(19) United States
(12) Patent Application Publication
(10) Pub. No.: US 2010/0058629 A1
(43) Pub. Date: Mar. 11, 2010

(54) LAB ANIMAL EAR TAG

(75) Inventors: Joan Emily Malcolm ALBEE, Sullivan, ME (US); Shannon Byers, Lamoine, ME (US); Michael V. Wiles, Mount Desert, ME (US)

Correspondence Address: Vedder Price, PC, 875 15th Street, NW, Suite 725, Washington, DC, 20005, US

(73) Assignee: The Jackson Laboratory, Bar Harbor, ME (US)

(21) Appl. No.: 12/556,895

(22) Filed: Sep. 10, 2009

Related U.S. Application Data
(60) Provisional application No. 61/096,229, filed on Sep. 11, 2008.

(51) Int. Cl. G09F 3/04; G09F 3/00; G09F 3/02; G06K 19/06; H04Q 5/22

(52) U.S. Cl. 40/301; 235/494; 235/492; 340/10.42

(57) ABSTRACT

An animal ear tag that is sufficiently light and small that it may be secured to the ear of an animal without causing irritation to the animal or loss of attachment. The ear tag includes an identification code that may be in the form of human-readable or machine-readable indicia or an RFID tag mounted on or inside the ear tag. The ear tag may be part of a sequential set of ear tags arranged in a strip.

### CROSS-REFERENCE TO RELATED APPLICATION

This application claims priority from U.S. Provisional Patent Application No. 61/096,229 entitled “Lab Animal Ear Tag,” filed Sep. 11, 2008, the entire disclosure and contents which is incorporated herein by reference.

### BACKGROUND

1. Field of the Invention

The present invention relates to an animal ear tag.

2. Related Art

Current pendant design ear identification tags for lab rodents and identification tags that clip around the ear of lab rodents have various problems. For example, such tags may tear out, the animal may get its claw caught under the side of the tag, the tag may catch on another object, etc.

### SUMMARY

According to a first broad aspect of the present invention, there is provided an ear tag comprising: a plaque having a substantially flat shape and having an identification code; and two or more pins connected to the plaque for securing the ear tag to the ear of an animal; wherein at least two of the pins are each connected to each of two opposite sides of the plaque, respectively; and wherein the ear tag has a weight of about 0.06 g or less.

According to a second broad aspect of the present invention, there is provided an article comprising: a set of ear tags, each ear tag comprising: a plaque having a substantially flat shape and having an identification code; and two or more pins connected to the plaque for securing the ear tag to the ear of an animal; and a connection between each pair of adjacent ear tags of the set of ear tags: wherein at least two of the pins are each connected to each of two opposite sides of the plaque, respectively; wherein each ear tag has a weight of about 0.06 g or less; and wherein the set of ear tags is a sequential set of ear tags.

According to a third broad aspect of the present invention, there is provided a method comprising the following steps: (a) inserting each of the two or more pins of an ear tag into the ear of an animal so that a plaque of the ear tag sits substantially flat and immobilized on one surface of an animal ear; and (b) bending each of the pins so that the pins are substantially parallel to a second surface of the animal ear to thereby secure the ear tag to the animal ear, wherein the plaque has an identification code and the two or more pins extend downwardly from the plaque in step (a).

### BRIEF DESCRIPTION OF THE DRAWINGS

The invention will be described in conjunction with the accompanying drawings, in which:

FIG. 1 is top perspective view of an ear tag in a flat configuration according to one embodiment of the present invention;

FIG. 2 is a top view of the ear tag of FIG. 1;

FIG. 3 is a side view of the ear tag of FIG. 1;

FIG. 4 is a sectional view of a pin of the ear tag of FIG. 1;

FIG. 5 is top perspective view of an ear tag in a flat configuration according to one embodiment of the present invention;

FIG. 6 is a top view of the ear tag of FIG. 5;

FIG. 7 is a side view of the ear tag of FIG. 5;

FIG. 8 is a sectional view of a pin of the ear tag of FIG. 5;

FIG. 9 is top perspective view of an ear tag in a flat configuration according to one embodiment of the present invention;

FIG. 10 is a top view of the ear tag of FIG. 9;

FIG. 11 is a side view of the ear tag of FIG. 9;

FIG. 12 is a sectional view of a pin of the ear tag of FIG. 9;

FIG. 13 is a top perspective view of the ear tag of FIG. 1 in an insertion configuration according to one to one embodiment of the present invention;

FIG. 14 is a sectional view of the ear tag of FIG. 13 inserted into the ear of an animal with the ear shown schematically by shadow lines;

FIG. 15 is a sectional view of the ear tag of FIG. 14 in which the pins of the ear tag have been bent outwardly to secure the ear tag to the ear of the animal;

FIG. 16 is an image of an ear tag without indicia that has been mounted in the ear of a mouse according to one embodiment of the present invention;

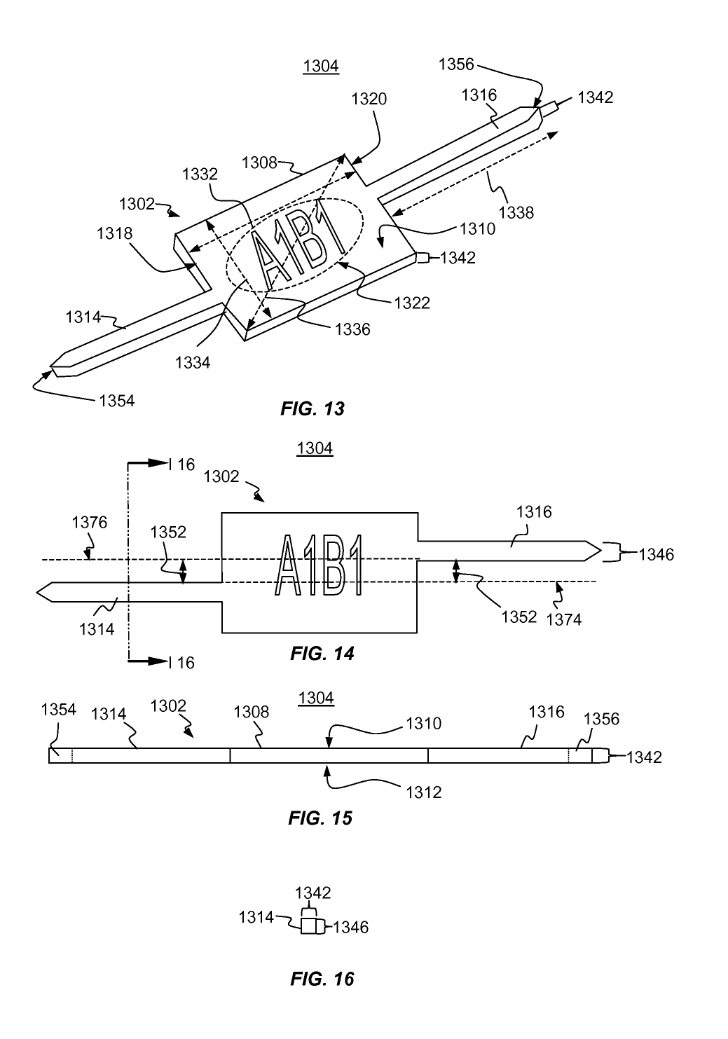

FIG. 13 is top perspective view of an ear tag in a flat configuration according to one embodiment of the present invention having offset pins;

FIG. 14 is a top view of the ear tag of FIG. 13;

FIG. 15 is a side view of the ear tag of FIG. 13;

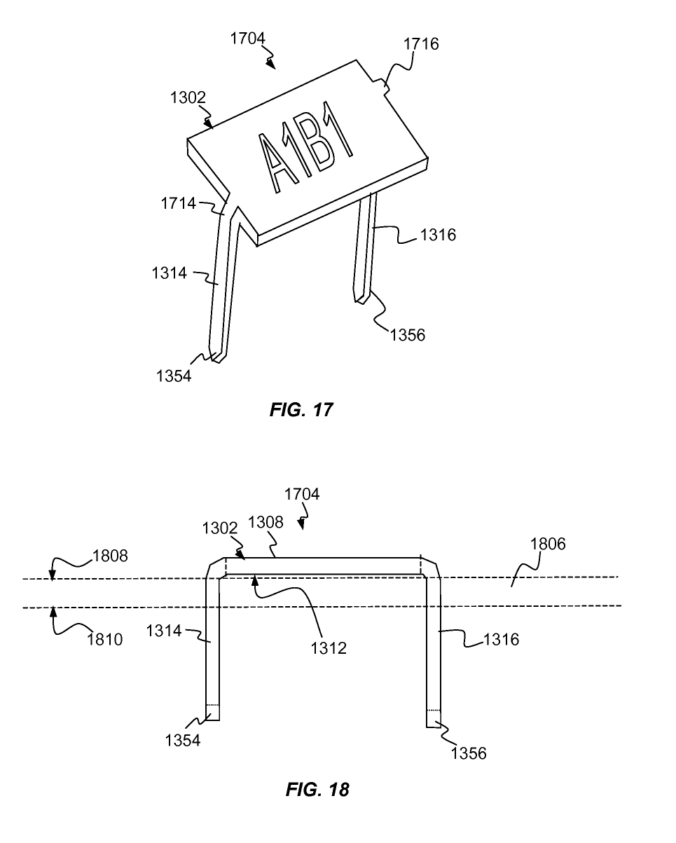

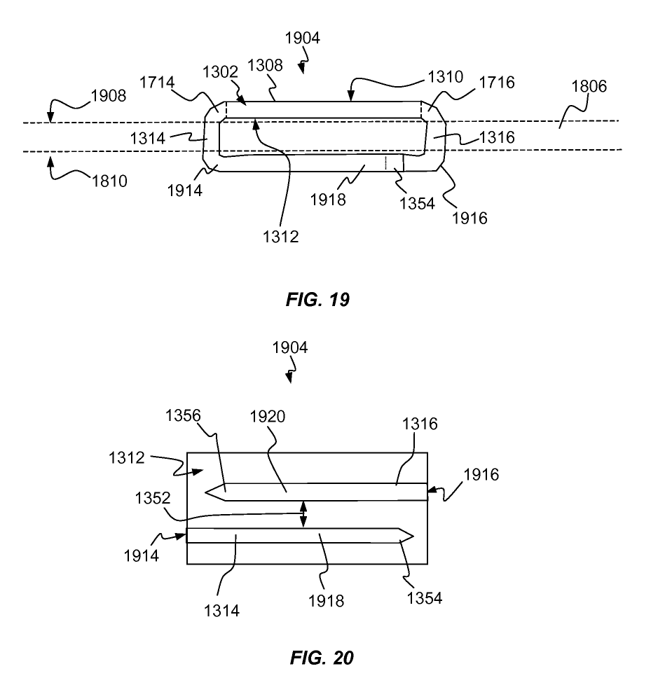

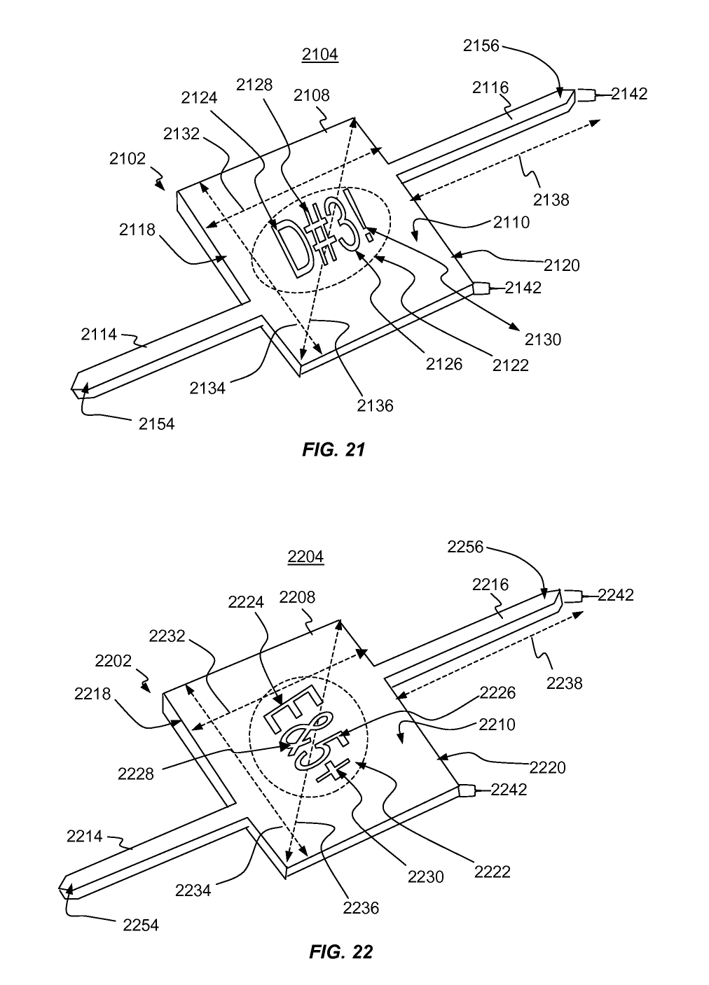

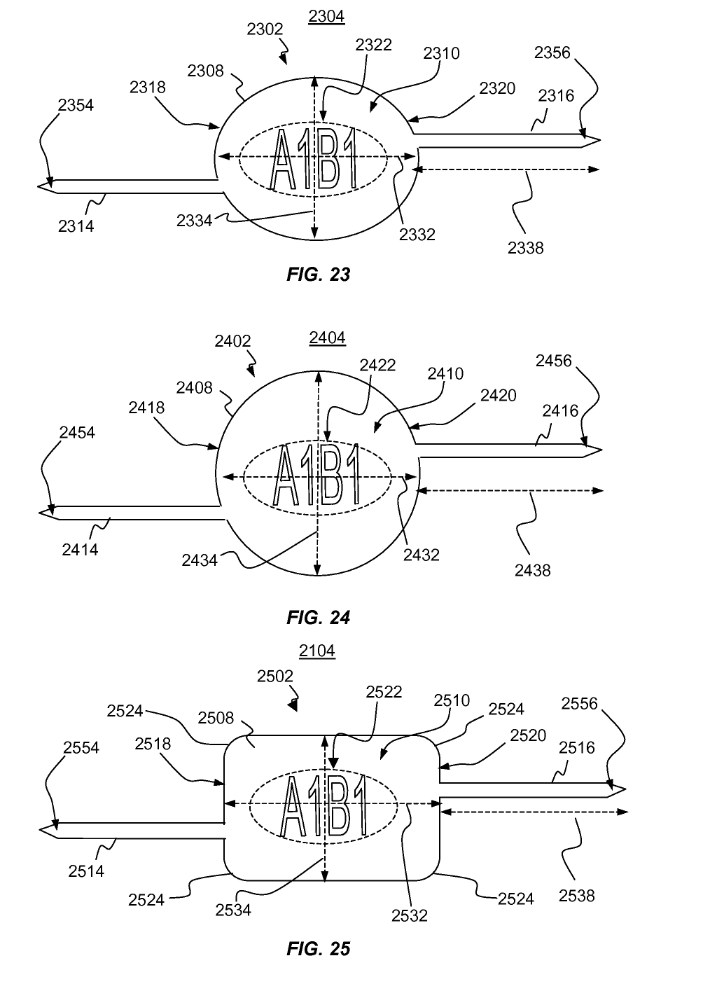

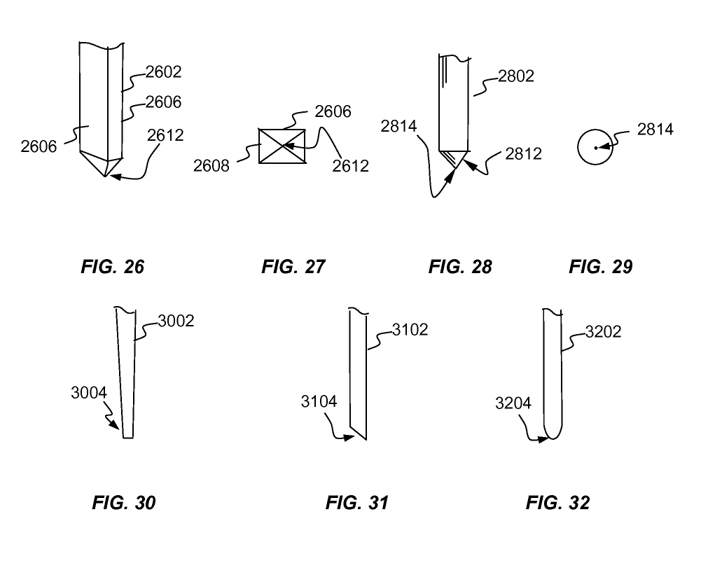

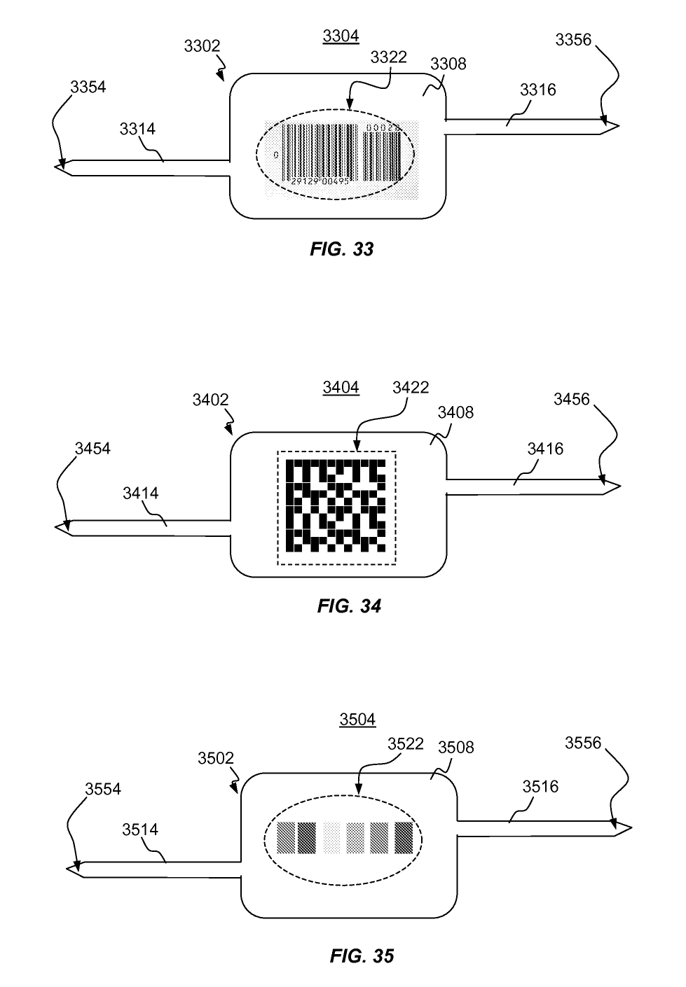

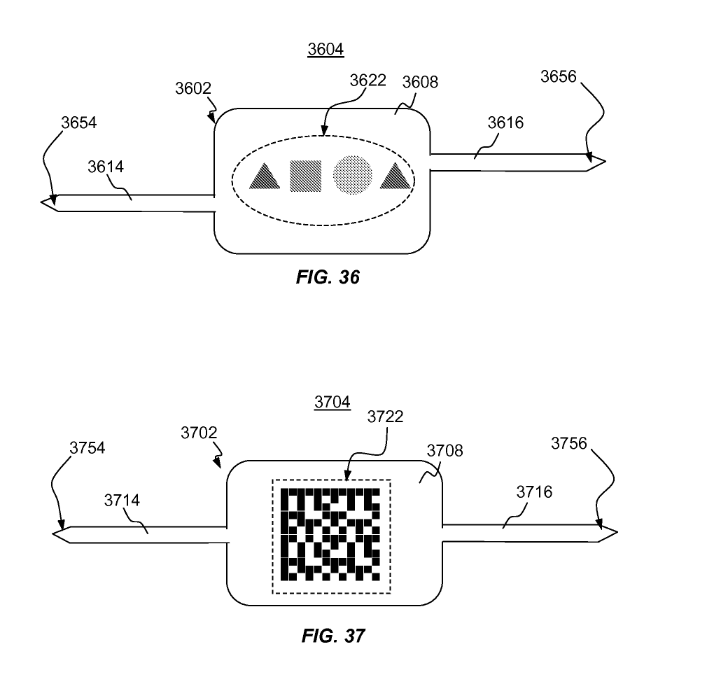

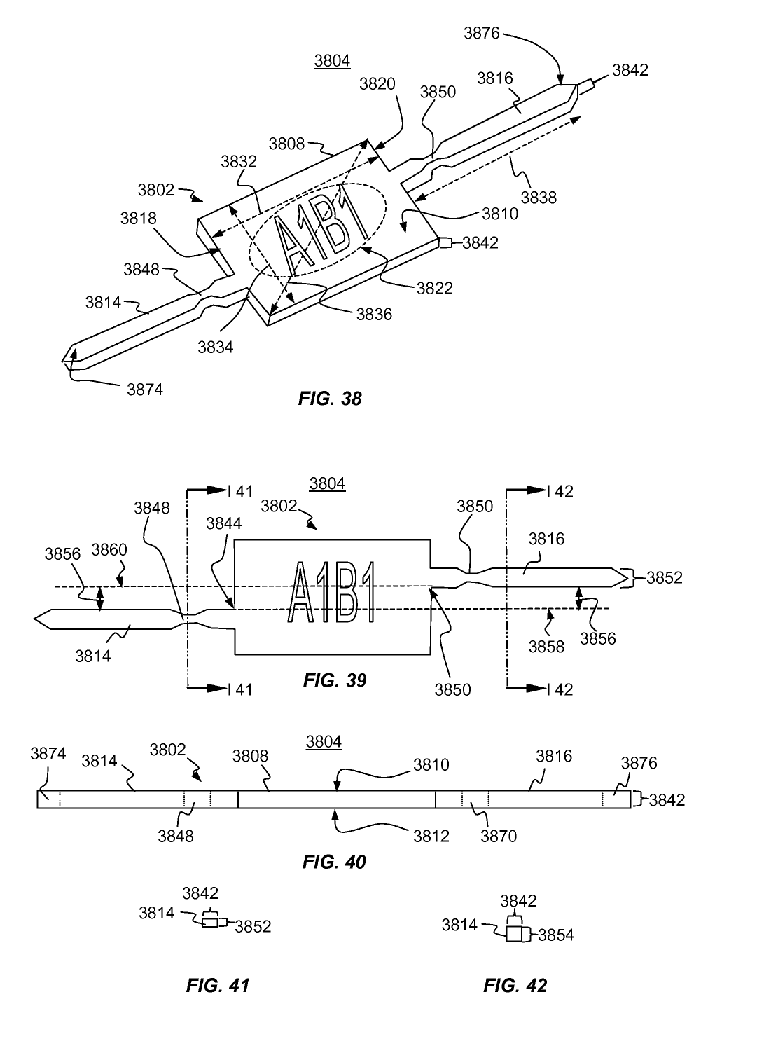

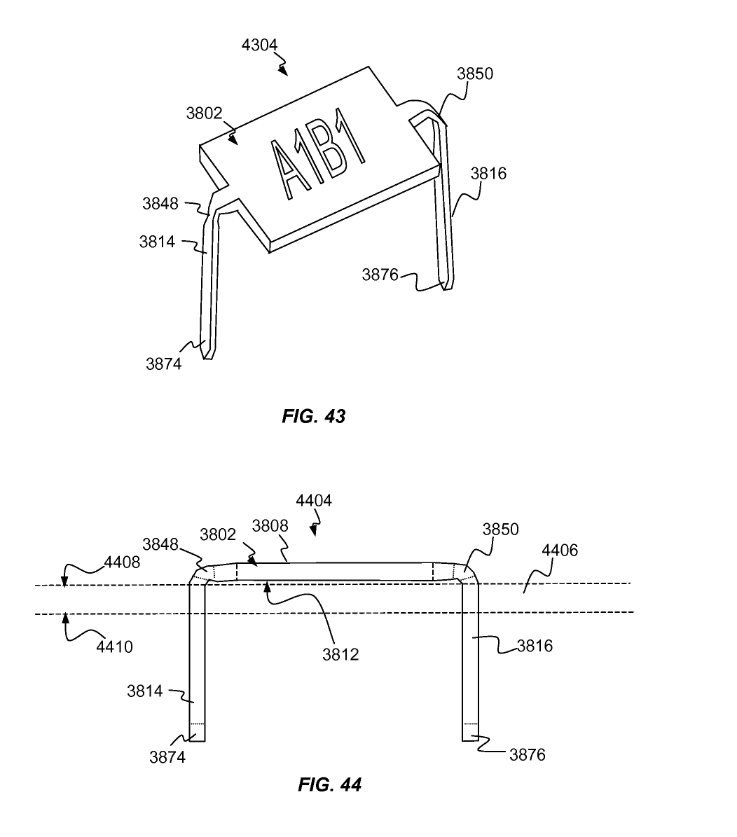

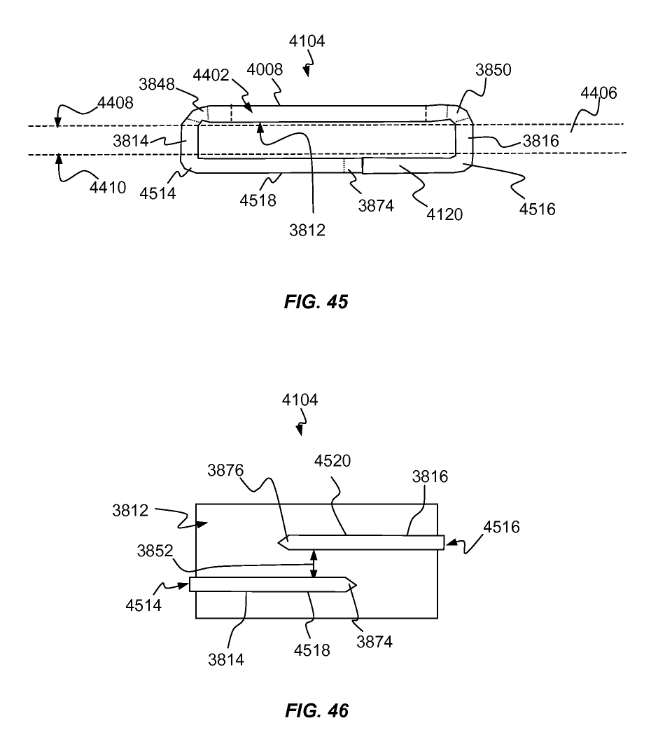

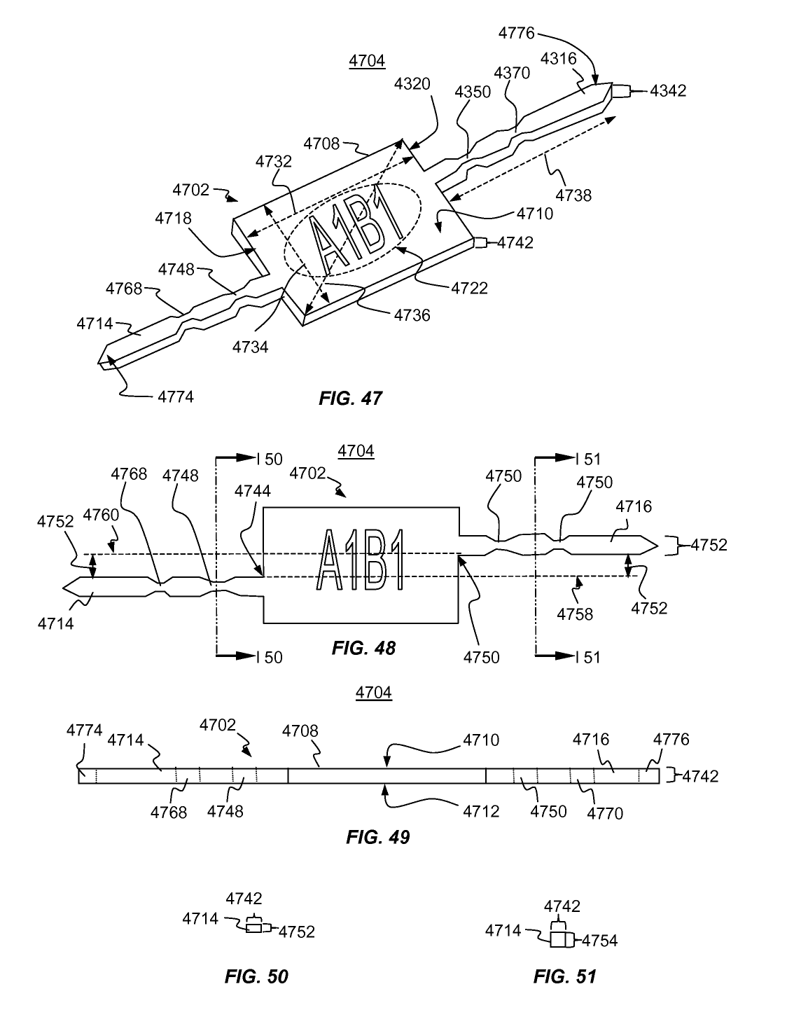

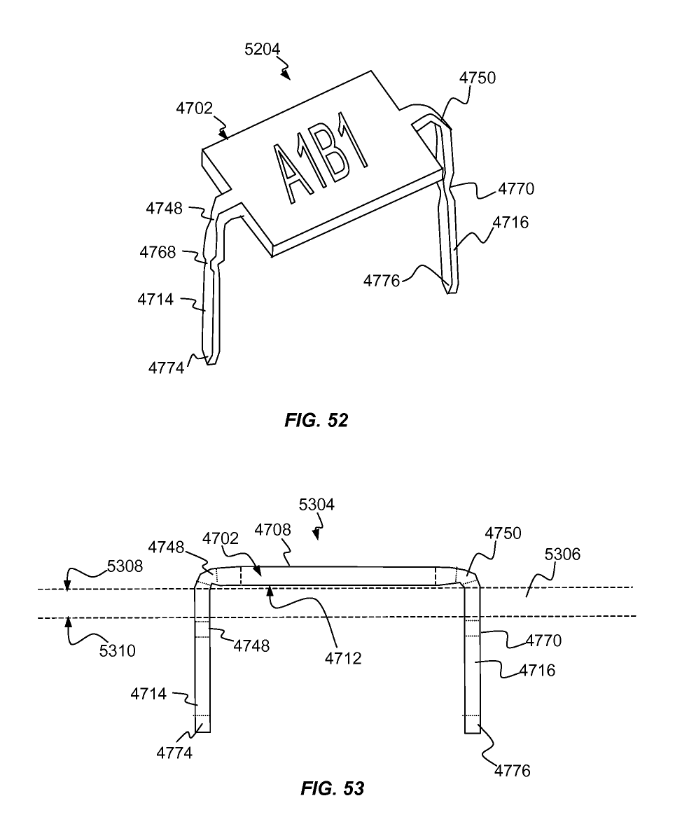

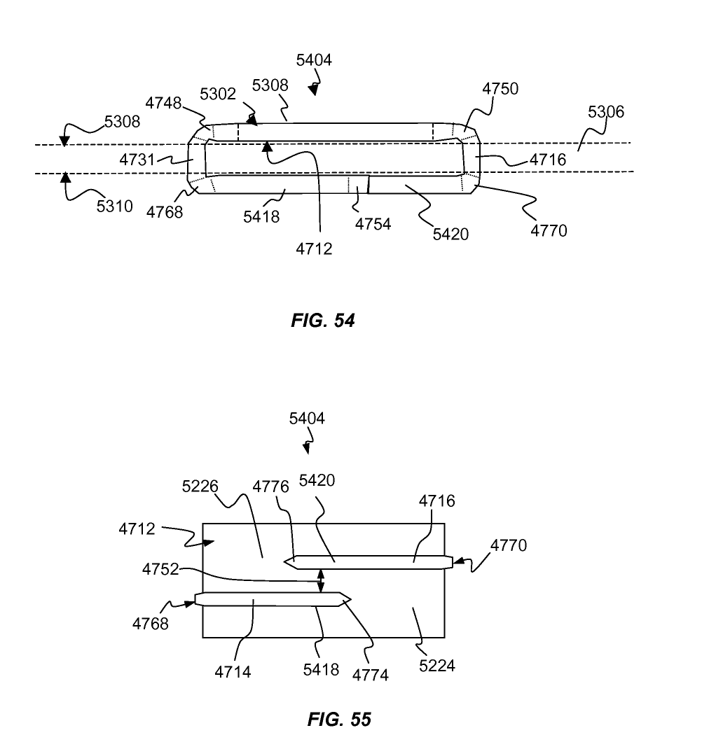

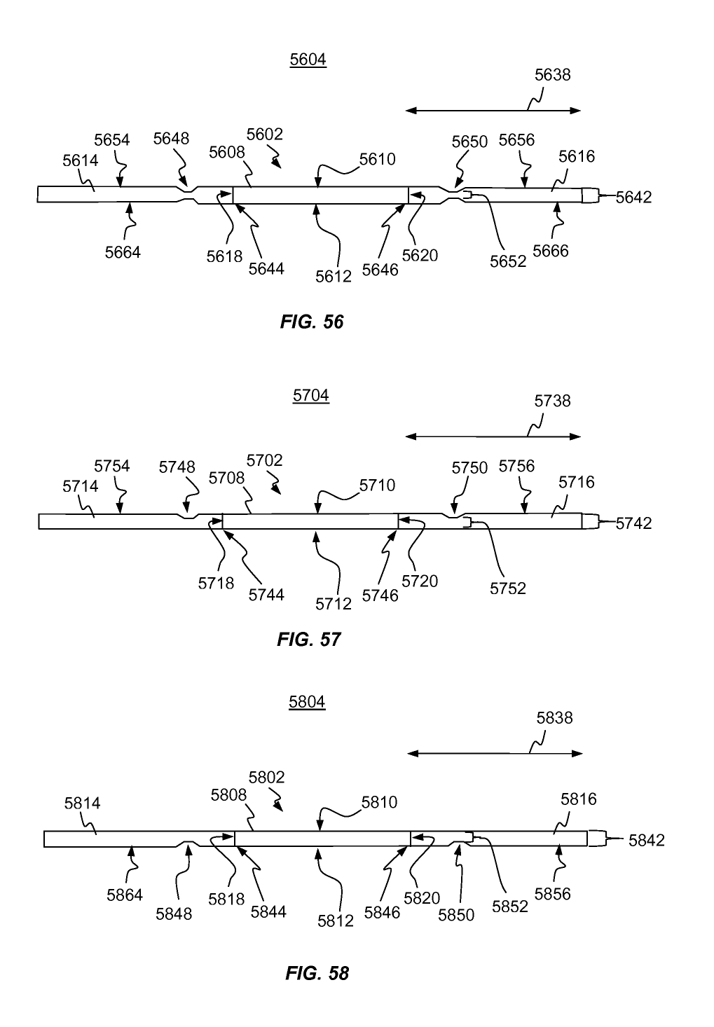

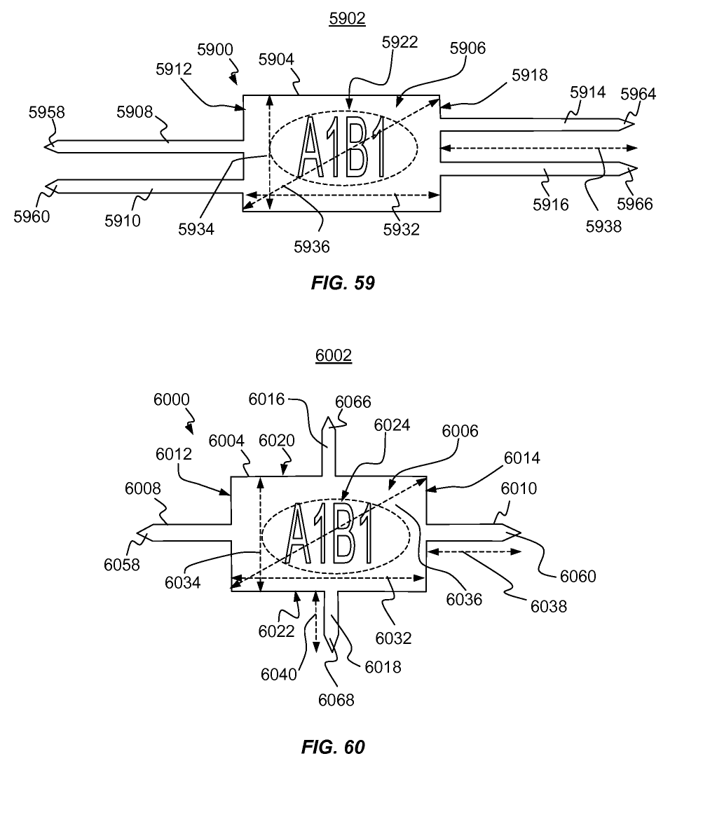

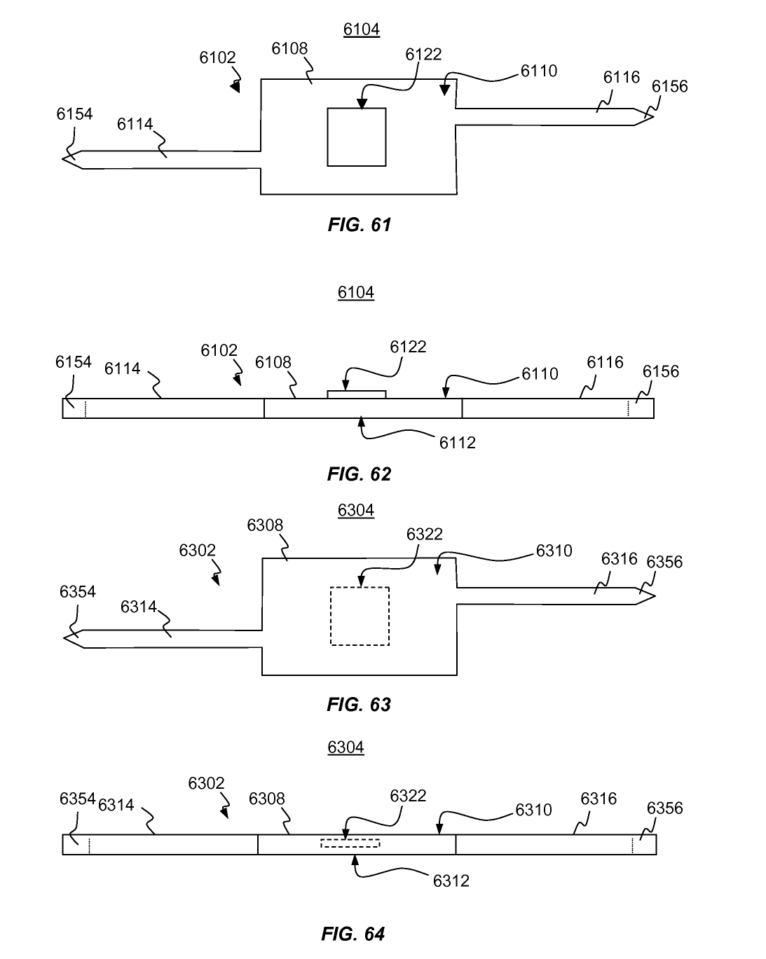

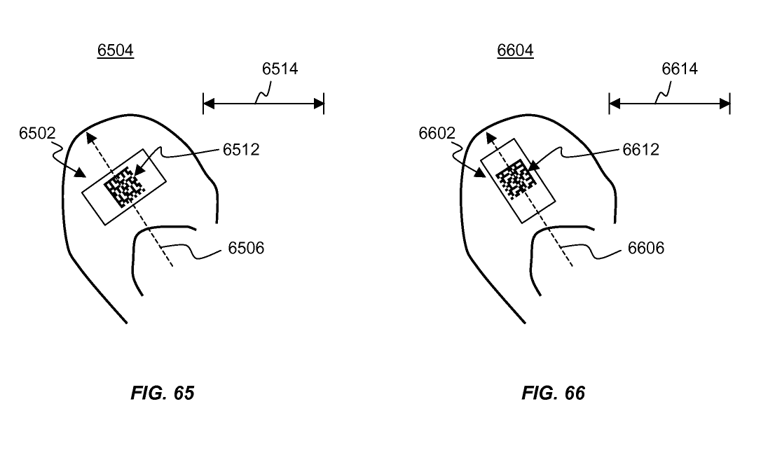

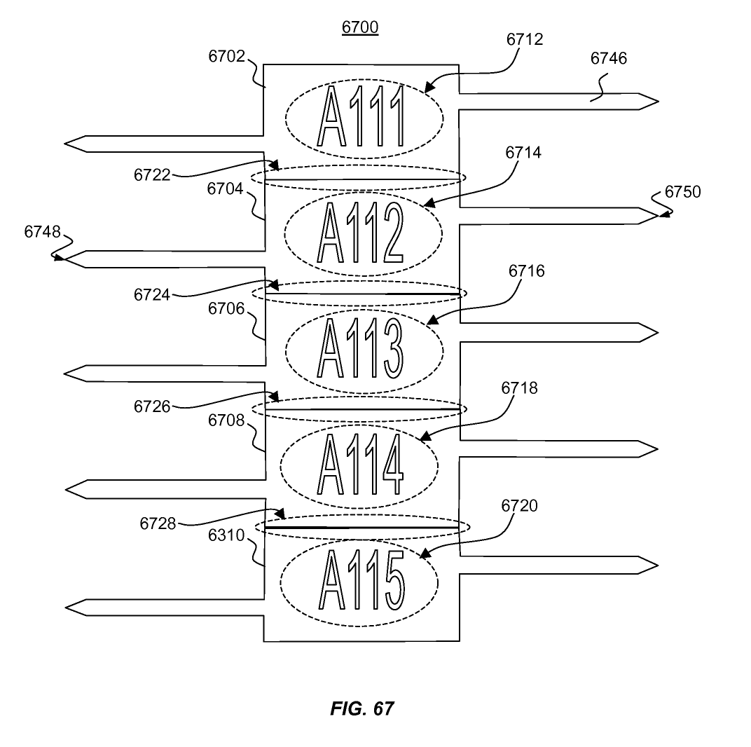

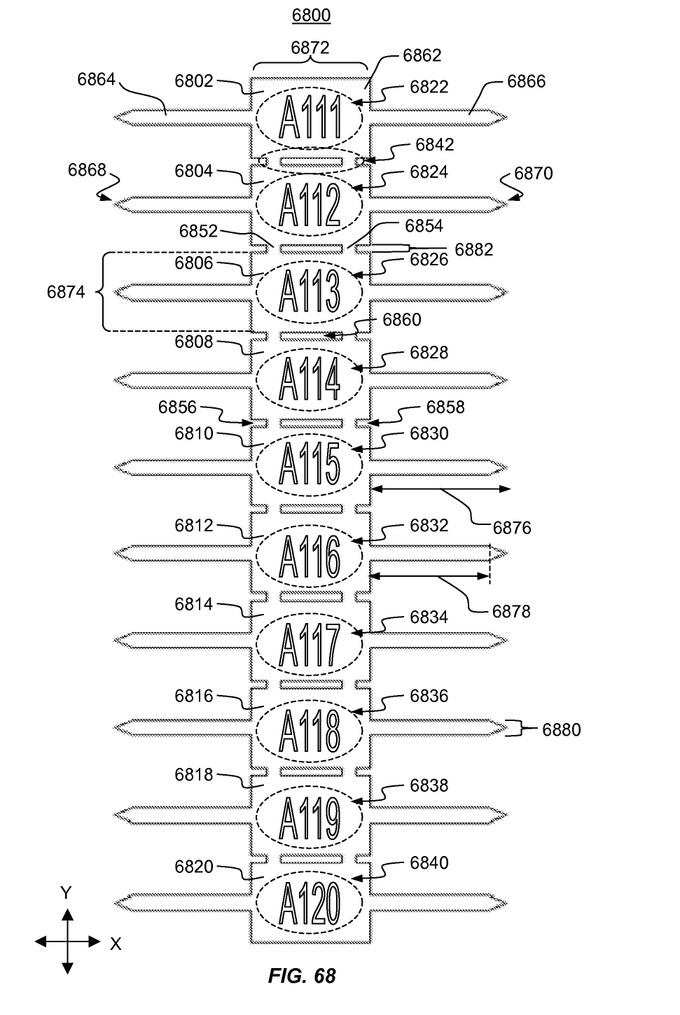

FIG. 16 is a sectional view of a pin of the ear tag of FIG. 14 along section line 16-16;

FIG. 17 is a top perspective view of the ear tag of FIG. 13 in an insertion configuration according to one to one embodiment of the present invention;

FIG. 18 is a sectional view of the ear tag of FIG. 18 inserted into the ear of an animal with the ear shown schematically by shadow lines;

FIG. 19 is a sectional view of the ear tag of FIG. 18 in which the pins of the ear tag have been bent inwardly to secure the ear tag to the ear of the animal;

FIG. 20 is a bottom view of the ear tag of FIG. 19 with the ear of the animal omitted for clarity of illustration;

FIG. 21 is a top perspective view of an ear tag in a flat configuration according to one embodiment of the present invention in which the ear tag is wider than it is long and the indicia is oriented parallel to the length of the ear tag;

FIG. 22 is a top perspective view of an ear tag in a flat configuration according to one embodiment of the present invention in which the ear tag is wider than it is long and the indicia is oriented parallel to the width of the ear tag;

FIG. 23 is a top view of an ear tag having an elliptical plaque according to one embodiment of the present invention;

FIG. 24 is a top view of an ear tag having a circular plaque according to one embodiment of the present invention;

FIG. 25 is a top view of an ear tag having a rounded corner rectangular plaque according to one embodiment of the present invention;

FIG. 26 is a side perspective view of a pin having a rectangular cross-section according to one embodiment of the present invention;

FIG. 27 is a bottom plan view of the distal end of the pin of FIG. 26;

FIG. 28 is a side perspective view of a cylindrical pin according to one embodiment of the present invention;

FIG. 29 is a bottom plan view of the distal end of the pin of FIG. 28;

FIG. 30 is a side view of a pin having a tapered end according to one embodiment of the present invention;

FIG. 31 is a side view of a pin having a beveled end according to one embodiment of the present invention;

FIG. 32 is a side view of a pin having a curved blunt end according to one embodiment of the present invention;

FIG. 33 is a top view of a rounded corner rectangular ear tag with a 1-dimensional bar code according to one embodiment of the present invention;

FIG. 34 is a top view of a rounded corner rectangular ear tag with a 2-dimensional bar code (2D bar code) according to one embodiment of the present invention;

FIG. 35 is a top view of a rounded corner rectangular ear tag with a color-based code according to one embodiment of the present invention;

FIG. 36 is a top view of a rounded corner rectangular ear tag with a color-based and shaped-based code according to one embodiment of the present invention;

FIG. 37 is a top view of a rounded corner rectangular ear tag with a 2-dimensional bar code (2D bar code) according to one embodiment of the present invention;

FIG. 38 is top perspective view of an ear tag in a flat configuration according to one embodiment of the present invention having offset pins with respective preferential bending regions;

FIG. 39 is a top view of the ear tag of FIG. 38;

FIG. 40 is a side view of the ear tag of FIG. 38;

FIG. 41 is a sectional view of a pin of the ear tag of FIG. 39 along section line 41-41;

FIG. 42 is a sectional view of a pin of the ear tag of FIG. 39 along section line 42-42;

FIG. 43 is a top perspective view of the ear tag of FIG. 38 in an insertion configuration according to one to one embodiment of the present invention;

FIG. 44 is a sectional view of the ear tag of FIG. 43 inserted into the ear of an animal with the ear shown schematically by shadow lines;

FIG. 45 is a sectional view of the ear tag of FIG. 43 in which the pins of the ear tag have been bent inwardly to secure the ear tag to the ear of the animal;

FIG. 46 is a bottom view of the ear tag of FIG. 45 with the ear of the animal omitted for clarity of illustration;

FIG. 47 is top perspective view of an ear tag in a flat configuration according to one embodiment of the present invention having offset pins with respective preferential bending regions;

FIG. 48 is a top view of the ear tag of FIG. 47;

FIG. 49 is a side view of the ear tag of FIG. 47;

FIG. 50 is a sectional view of a pin of the ear tag of FIG. 48 along section line 50-50;

FIG. 51 is a sectional view of a pin of the ear tag of FIG. 48 along section line 51-51;

FIG. 52 is a top perspective view of the ear tag of FIG. 47 in an insertion configuration according to one to one embodiment of the present invention;

FIG. 53 is a sectional view of the ear tag of FIG. 52 inserted into the ear of an animal with the ear shown schematically by shadow lines;

FIG. 54 is a sectional view of the ear tag of FIG. 52 in which the pins of the ear tag have been bent inwardly to secure the ear tag to the ear of the animal;

FIG. 55 is a bottom view of the ear tag of FIG. 54 with the ear of the animal omitted for clarity of illustration;

FIG. 56 is a side view of an ear tag according to one embodiment of the present invention having pins with respective preferential bending regions;

FIG. 57 is a side view of an ear tag according to one embodiment of the present invention having pins with respective preferential bending regions;

FIG. 58 is a side view of an ear tag according to one embodiment of the present invention having pins with respective preferential bending regions;

FIG. 59 is a top view of an ear tag with two pins extending from each of two opposite sides according to one embodiment of the present invention;

FIG. 60 is a top view of an ear tag with pins extending from the four sides of the ear tag according to one embodiment of the present invention;

FIG. 61 is a schematic top view of an ear tag including an RFID tag according to one embodiment of the present invention;

FIG. 62 is a schematic side view of the ear tag of FIG. 61;

FIG. 63 is a schematic top view of an ear tag including an RFID tag according to one embodiment of the present invention;

FIG. 64 is a schematic side view of the ear tag of FIG. 63;

FIG. 65 is a schematic view of an ear tag of the present invention secured to a mouse ear in one position;

FIG. 66 is a schematic view of an ear tag of the present invention secured to a mouse ear in a second position;

FIG. 67 is a top view of a sequential set of ear tags according to one embodiment of the present invention; and

FIG. 68 is a top view of a sequential set of ear tags according to one embodiment of the present invention.

### DETAILED DESCRIPTION

It is advantageous to define several terms before describing the invention. It should be appreciated that the following definitions are used throughout this application.

### DEFINITIONS

Where the definition of terms departs from the commonly used meaning of the term, applicant intends to utilize the definitions provided below, unless specifically indicated.

For the purposes of the present invention, directional terms such as “top”, “bottom”, “upper”, “lower”, “above”, “below”, “left”, “right”, “horizontal”, “vertical”, “upward”, “downward”, “proximal”, “distal”, etc. are merely used for convenience in describing the various embodiments of the present invention.

For the purposes of the present invention, the term “alpha-numeric” refers to identification codes including numbers and/or letters. Examples of alpha-numeric codes include: 132, ADB, 8A3, X24, etc.

For the purposes of the present invention, the term “axis” for an animal ear refers to the major axis of growth elongation of the ear.

For the purposes of the present invention, the term “distal end” refers to the free end of a pin.

For the purposes of the present invention, the term “identification code” refers to a code that identifies an animal to which an ear tag of the present invention has been attached. The identification code may also include various information about the animal in addition to a code that uniquely identifies the animal. For example, the identification code may include information about the date the animal was tagged, the parentage of the animal, the experiment being conducted on the animal, etc.

For the purposes of the present invention, the term “proximal end” refers to the end of a pin that joins the plaque to which the pin is joined.

For the purpose of the present invention, the term “sequential set of ear tags” refers to ear tags that are arranged in a set or strip of ear tags so that the respective codes of the ear tags form a sequence. The codes of the ear tags may be human-readable and/or machine-readable.

For the purposes of the present invention, the term “unibody construction” or “unibody” refers to an ear tag made from a single piece of material.

For the purposes of the present invention, the term “frangible” refers to any type of breakable connection between two items, such as two ear tags. For example, if two adjacent ear tags are formed from a single piece of material, the frangible connection may be a weakened piece of material between the ear tags that may be preferentially broken to allow the two or more ear tags to be separated. The material may be weakened by perforation, engraving, indentation, thinning, etc. Alternatively, the frangible connection may be a dry adhesive between two ear tags that is preferentially broken to separate the ear tags from each other in a manner that is similar to the way staples are separated from each other. A specific example of a frangible connection is shown in FIG. 68.

For the purposes of the present invention, the term “human-readable” refers to indicia that may be understood by a human. Human-readable indicia may take the form of letters, numbers, symbols, shapes, colors, etc., or any combination thereof. Human-readable indicia generally comprise an indicia that is understandable by a human. Such human-readable indicia may also correspond to or be translatable into a particular number or letter, or any combination of numbers and/or letters that may be interpreted by a human. For example, the sequential combination of a blue triangle, red square and yellow circle could stand for the alpha-numeric code 12A, with the blue triangle standing for 1, the red square for 2 and the yellow circle for A. Human-readable indicia may be read by a human using the naked eye, or, usually, given the size of the indicia of the invention with the aid of one or more optical magnifying lenses, a still camera, a movie camera, a video-recorder, etc that may be used to aid a human in reading the visible indicia.

For the purposes of the present invention, the term “indicia” refers to markings on the plaque of a tag of the present invention. Indicia may be combinations letters and/or numbers, and/or symbols and/or colors and/or shapes and/or codes, etc. Indicia may be “human-readable” and/or “machine-readable.”

For the purposes of the present invention, the term “length” with respect to plaques with pins extending from only two sides of the plaque refers the distance across a plaque in the direction parallel to which the pins extend from the plaque. For plaques with pins extending from more than two sides and for circular plaques, the term “length” refers to the longest dimension of the plaque aligned in parallel with at least one pin. With respect to pins, the term “length” refers to the longest dimension of a pin.

For the purposes of the present invention, the term “machine-readable code” refers to code that is readable by a machine, such as a scanner, computer, PDA, cell phone, etc. Machine-readable indicia are one type of a machine-readable code, but human-readable code may be stored in a device, such as an RFID, that is mounted on or mounted in an ear tag.

For the purposes of the present invention, the term “machine-readable indicia” refers to indicia that are readable by a machine such as a scanner, computer, PDA, cell phone, etc. Examples of machine-readable indicia include 1-dimensional bar codes, 2D bar codes, matrix codes, etc. Some machine-readable indicia may also be human-readable. For example, numbers, letters, colors, symbols, etc may be both human-readable and machine-readable.

For the purposes of the present invention, the term “maximum diameter” with respect to a plaque refers to the longest line across the plaque, including diagonal lines. The maximum diameter of a rectangular plaque corresponds to a diagonal distance between two opposite corners of the plaque. For example, for a square plaque that has a width and length of 5 mm, the maximum diameter will be a 7.07 mm, i.e. about 7.1 mm.

For the purposes of the present invention, the term “preferential bending region” refers to a portion of a pin of the present that is thinned, flattened, weakened, etc. so that when pressure is applied to the end of the pin, the pin will preferentially bend in this region.

For the purposes of the present invention, the term “thickness” for a plaque refers to the dimension of the plaque perpendicular to the upper and lower surfaces of the plaque. The term “thickness” for a pin refers to the dimension of the pin perpendicular to the upper and lower surfaces of the plaque.

For the purposes of the present invention, the term “width” with respect to a plaque refers to the dimension that is perpendicular to the length of the plaque in the plane of the upper or lower surface of the plaque. For the purposes of the present invention, with respect to a pin, the term “width” refers to a dimension of the pin perpendicular to the length of the pin and co-planar with either the upper or lower surface of the plaque.

### Description

The plaque of the ear tag is designed to be substantially flat and immobilized when secured to an animal. This prevents the ear tag from catching on anything in the animal's external environment, such as the wires of the cage in which the animal is kept. The animal also tends to ignore a small, flat and immobilized tag during grooming. It is important that the ear tag have a small size and weight to prevent detachment and irritation of the ear of the animal.

The ear tag is designed so that the ear of the animal is not crushed between the tag body and the pins as a result of its application to the ear. In one embodiment, the plaque of the ear tag may be oriented on the animal's ear at right angles to the major access of elongation of the ear during growth of the animal, thereby allowing the tag to be applied to ears of young animals and left attached for an extensive period of time (perhaps over the life of the animal) without tearing the ear or causing the ear to loop out away from the surface of the plaque.

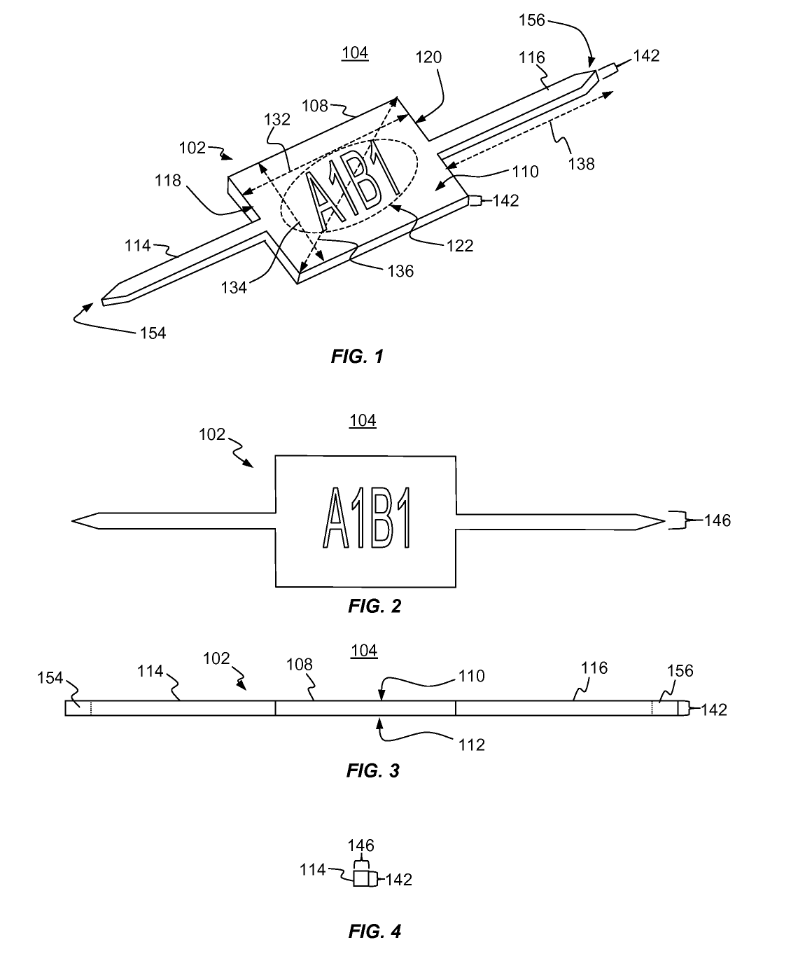

FIGS. 1, 2 and 3 show one embodiment of a rectangular unibody ear tag 102 of the present invention in a flat configuration 104. Ear tag 102 includes a rectangular plaque 108 having an upper surface 110 and a lower surface 112. Pins 114 and 116 extend from opposite sides 118 and 120 of plaque 108. Upper surface 110 of plaque 108 has alpha-numeric indicia 122. Plaque 108 has a length lₚ₁ indicated by double-headed arrow 132, a width wₚ₁ indicated by double-headed arrow 134 and a maximum diameter dₘₐₓ₁ indicated by double-headed arrow 136. Pins 114 and 116 each have a length lₙ₁ indicated by double-headed arrow 138. Plaque 108 and pins 114 and 116 have a thickness tₙ shown by bracket 142. Pins 114 and 116 are each rectangular. Indicia 122 are oriented parallel to length lₚ₁. A cross section of pin 114 is shown in FIG. 4, and the cross-section of pin 116 is identical. Length lₚ₁ of ear tag 102 is shown greater than width wₚ₁ of ear tag 102. Length lₙ₁ is approximately equal to length lₚ₁. Pins 114 and 116 each have a width wₙ₁ shown by bracket 146. Pins 114 and 116 have pointed distal ends 154 and 156 respectively. Pointed distal ends 154 and 156 taper on two sides so that width wₚ₁ of ear tag 102 is reduced.

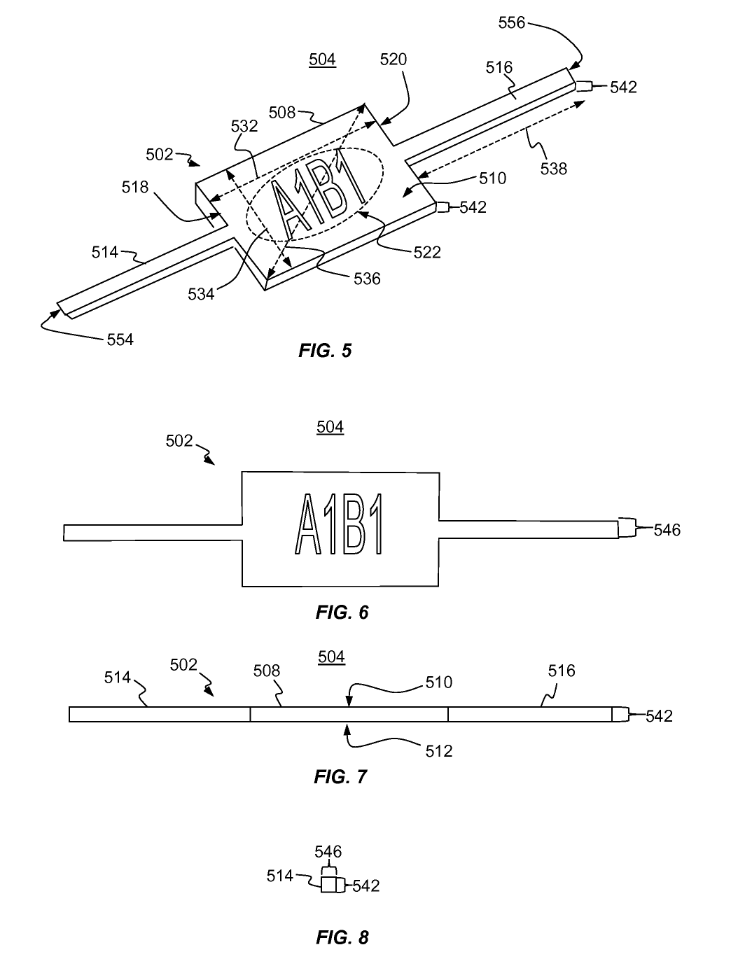

FIGS. 5, 6 and 7 show one embodiment of a rectangular unibody ear tag 502 of the present invention in a flat configuration 504. Ear tag 502 includes a rectangular plaque 508 having an upper surface 510 and a lower surface 512. Pins 514 and 516 extend from opposite sides 518 and 520 of plaque 508. Upper surface 510 of plaque 508 has alpha-numeric indicia 522. Plaque 508 has a length lₚ₅ indicated by double-headed arrow 532, a width wₚ₅ indicated by double-headed arrow 534 and a maximum diameter dₘₐₓ₅ indicated by double-headed arrow 536. Pins 514 and 516 each have a length lₙ₅ indicated by double-headed arrow 538. Plaque 508 and pins 514 and 516 have a thickness tₙ₅ shown by bracket 542. Pins 514 and 516 are each rectangular. Indicia 522 are oriented parallel to length lₚ₅. A cross section of pin 514 is shown in FIG. 8, and the cross-section of pin 516 is identical. Length lₚ₅ of ear tag 502 is shown greater than width wₚ₅ of ear tag 502. Although in the embodiment of FIGS. 5-8, length lₙ₅ is approximately equal to length lₚ₅, in other embodiments length ln₅ may exceed length lp₅. Pins 514 and 516 each have a width wₙ₅ shown by bracket 546. Pins 514 and 516 have flat distal ends 554 and 556 respectively. Pointed distal ends 554 and 556 taper on two sides so that width wₚ₅ of ear tag 502 is reduced.

Although two types of ends, pointed and rounded, are shown in the embodiments of FIGS. 1, 2, 3, 4, 5, 6, 7 and 8, the pins of the present invention may have various types ends including blunt, rounded, slanted, etc. Also, although the ends of the pins in the embodiments of FIGS. 1, 2, 3, 4, 5, 6, 7 and 8 are shown as being the same, the two ends may have different shapes. For example, one end may be pointed and one end may be flat.

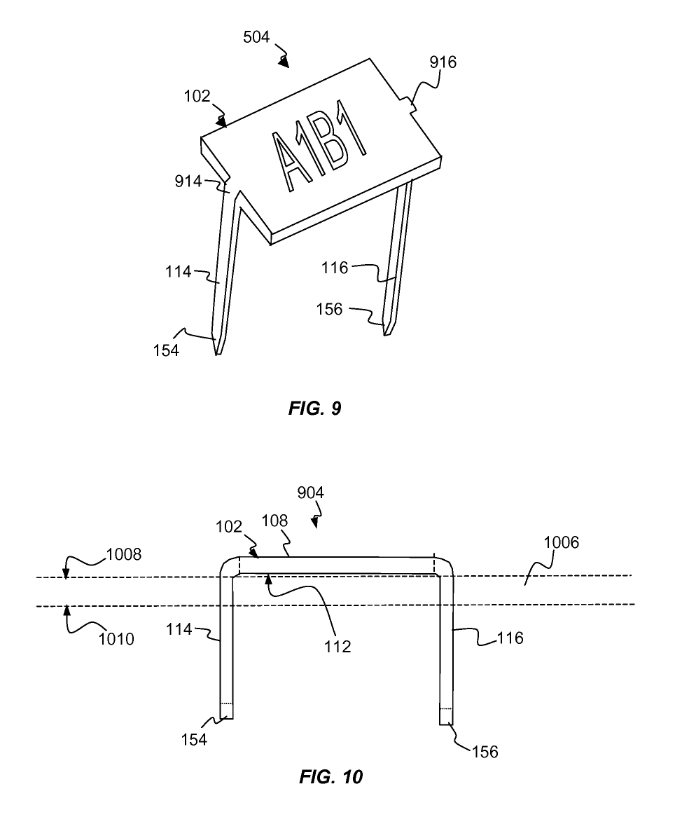

FIG. 9 shows ear tag 102 in a insertion configuration 904 according to one embodiment of the present invention in which pins 114 and 116 have been bent at respective bends 914 and 916 so that pins 114 and 116 bend downwardly at a substantially right angle so that pin distal ends 154 and 156 may be inserted through the ear of an animal as shown in FIG. 10.

FIG. 10 show ear tag 102 in a insertion configuration 904 in which pins 114 and 116 are inserted through animal ear 1006 so that plaque 108 rests substantially flat against a upper surface 1008 of an animal ear 1006. Animal ear 1006 also includes a lower surface 1010 that is opposite upper surface 1008. Either upper surface 1008 or lower surface 1010 may be the upper or lower surface of the animal ear, with the other surface being the opposite surface.

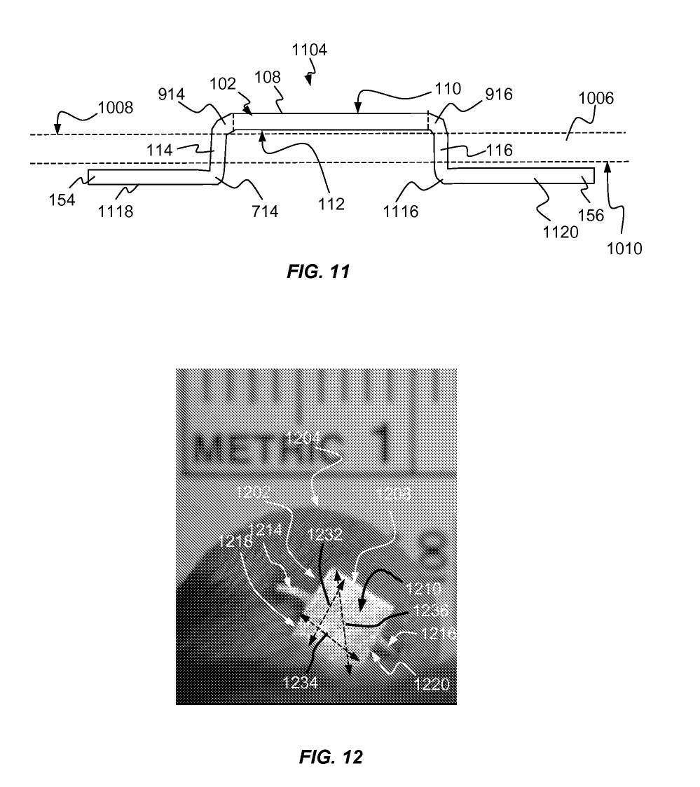

FIG. 11 shows ear tag 102 in a secured configuration 1104 in which pins 114 and 116 have been bent at bends 1114 and 1116, respectively, so that retaining sections 1118 and 1120, respectively of pins 114 and 116 extend outwardly from plaque 108. Retaining sections 1118 and 1120 extend substantially parallel to the lower surface 1010 of animal ear 1006 to prevent pins 114 and 116 from being pulled upwardly back through ear 1006 and to thereby secure ear tag 102 to animal ear 1006.

FIG. 12 shows an embodiment of a unibody ear tag 1202 of the present invention without indicia secured to an ear 1204 of a mouse. Ear tag 1202 includes a plaque 1208 having an upper surface 1210 and a lower surface (not visible in FIG. 12). Pins 1214 and 1216 extend from opposite sides 1218 and 1220 of plaque 1208. Pins 1214 and 1216 are bent to curve downwardly to allow pins 1214 and 1216 to be inserted in mouse ear 1204 and to allow plaque 1208 to lie flat and immobilized on mouse ear 1204. Plaque 1208 has a length lₚ₁₆ indicated by double-headed arrow 1232, a width wₚ₁₂ indicated by double-headed arrow 1234 and a maximum diameter dₘₐₓ₁₂ indicated by double-headed arrow 1236. Ear tag 1202 is held in place on ear 1204 by in a fashion similar to the secured configuration of FIG. 11. Distal ends (not visible) of pins 1214 and 1214 are bent outwardly by human pushing down and out on the distal ends.

Bending the pins outwardly to secure the ear tags of FIGS. 1, 2, 3, 4, 9, 10, 11 and 12 prevents the pins from contacting each other or crossing over each when the pins are bent to secure the tags, as the pins might do if they were bent inwardly under the plaque to secure the pins.

In another embodiment of the present invention, the pins may be prevented from contacting each other or crossing over each other by making the pins shorter relative to the length of the plaque, thereby allowing the pins to be bent under the plaque. But shorter pins may lead to a less secure attachment of the ear tag to the ear of the animal.

In one embodiment of the present invention, to allow the pins to be bent under the plaque without contacting other or crossing over each other, the pins may be offset with respect to each other. One example of an ear tag of the present invention with offset pins is shown in FIGS. 13, 14 and 15, described below.

FIGS. 13, 14 and 15 show one embodiment of a rectangular unibody ear tag 1302 of the present invention in a flat configuration 1304. Ear tag 1302 includes a rectangular plaque 1308 having an upper surface 1310 and a lower surface 1312. Pins 1314 and 1316 extend from opposite sides 1318 and 1320 of plaque 1308. Upper surface 1310 of plaque 1308 has alpha-numeric indicia 1322. Plaque 1308 has a length lₚ₁₃ indicated by double-headed arrow 1332, a width wₚ₁₃ indicated by double-headed arrow 1334 and a maximum diameter dₘₐₓ₁₃ indicated by double-headed arrow 1336. Pins 1314 and 1316 each have a length lₙ₁₃ indicated by double-headed arrow 1338. Plaque 1308 and pins 1314 and 1316 have a thickness tₙ₁₃ shown by bracket 1342. Pins 1314 and 1316 are each rectangular. Indicia 1322 are oriented parallel to length lₚ₁₃. A cross section of pin 1314 is shown in FIG. 16, and the cross-section of pin 1316 is identical. Length lₚ₁₃ of ear tag 1302 is shown greater than width wₚ₁₃ of ear tag 1302. Length lₙ₁₃ is approximately equal to length lₚ₁₃. Pins 1314 and 1316 each have a width wₙ₁₃ shown by bracket 1346. Pins 1314 and 1316 are offset from each other by an offset distance oₚ₁₃ indicated from each other by double-headed arrows 1352. Pins 1314 and 1316 have pointed distal ends 1354 and 1356 respectively. Pointed distal ends 1354 and 1356 taper on two sides so that width wₚ₁₃ of ear tag 1302 is reduced. Shadow line 1374 corresponds to an edge of pin 1314 and shadow line 1376 corresponds to an edge of pin 1316.

FIG. 17 shows ear tag 1302 in an insertion configuration 1704 according to one embodiment of the present invention in which pins 1314 and 1316 have been bent at respective bends 1714 and 1716 so that pins 1314 and 1316 bend downwardly at a substantially right angle so that pin distal ends 1354 and 1356 may be inserted through the ear of an animal as shown in FIG. 18.

FIG. 18 show ear tag 1302 in an insertion configuration 1704 in which pins 1314 and 1316 are inserted through animal ear 1806 so that plaque 1308 rests substantially flat against a upper surface 1808 of an animal ear 1806. Animal ear 1806 also includes a lower surface 1810 that is opposite upper surface 1808. Either upper surface 1808 or lower surface 1810 may be the upper or lower surface of the animal ear, with the other surface being the opposite surface.

FIGS. 19 and 20 show ear tag 1302 in a secured configuration 1904 in which pins 1314 and 1316 have been bent at bends 1914 and 1916, respectively, so that retaining sections 1918 and 1920, respectively of pins 1314 and 1316 extend inwardly under plaque 1308. Retaining sections 1918 and 1920 extend substantially parallel to the lower surface 1810 of animal ear 1806 to prevent pins 1314 and 1316 from being pulled upwardly back through ear 1806 and to thereby secure ear tag 1302 to animal ear 1806. Retaining sections are separated from each other by offset distance o_{d13} shown by double-headed arrow 1352.

An ear tag of the present invention that is wider than it is long and has indicia oriented parallel the length of the ear tag is shown in FIG. 21. FIG. 21 shows a unibody ear tag 2102 according to one embodiment of the present invention in a flat configuration 2104. Ear tag 2102 includes a rectangular plaque 2108 having an upper surface 2110 and a lower surface (not visible in FIG. 21). Offset pins 2114 and 2116 extend from opposite sides 2118 and 2120 of plaque 2108. Upper surface 2110 of plaque 2108 has indicia 2122 including a letter 2124, a number 2126 and symbols 2128 and 2130. Plaque 2108 has a length lₚ₂₁ indicated by double-headed arrow 2132, a width wₚ₂₁ indicated by double-headed arrow 2134 and a maximum diameter dₘₐₓ₂₁ indicated by double-headed arrow 2136. Indicia 2122 are oriented parallel to length lₚ₂₁. Pins 2114 and 2116 each have a length lₙ₂₁ indicated by double-headed arrow 2138. Plaque 2108 and pins 2114 and 2116 have a thickness 2142. Plaque width wₚ₂₁ is greater than plaque length lₚ₂₁. Pins 2114 and 2116 have pointed distal ends 2154 and 2156 respectively. Pointed distal ends 2154 and 2156 taper on two sides so that width wₚ₂₁ of ear tag 2102 is reduced.

An ear tag of the present invention that is wider than it is long is shown and has indicia oriented parallel to the width of the ear tag is shown in FIG. 22. FIG. 22 shows a unibody ear tag 2202 according to one embodiment of the present invention in a flat configuration 2204. Ear tag 2202 includes a rectangular plaque 2208 having an upper surface 2210 and a lower surface (not visible in FIG. 22). Offset pins 2214 and 2216 extend from opposite sides 2218 and 2220 of plaque 2208. Upper surface 2210 of plaque 2208 has indicia 2222 including a letter 2224, a number 2226 and symbols 2228 and 2230. Plaque 2208 has a length lₚ₂₂ indicated by double-headed arrow 2232, a width wₚ₂₂ indicated by double-headed arrow 2234 and a maximum diameter dₘₐₓ₂₂ indicated by double-headed arrow 2236. Indicia 2222 are oriented parallel to length wₚ₂₂. Pins 2214 and 2216 each have a length lₙ₂₂ indicated by double-headed arrow 2238. Plaque 2208 and pins 2214 and 2216 have a thickness 2242. Plaque width wₚ₂₂ is greater than plaque length lₚ₂₂. Pins 2214 and 2216 have pointed distal ends 2254 and 2256 respectively. Pointed distal ends 2254 and 2256 taper on two sides so that width wₚ₂₂ of ear tag 2202 is reduced.

The plaque of the invention may have any shape, such as square, rectangular, rhomboid, elliptical, circular, etc. The shape may be symmetric, asymmetric, irregular, closed curve, etc.

FIG. 23 shows one embodiment of a unibody ear tag 2302 of the present invention in a flat configuration 2304. Ear tag 2302 includes an elliptical plaque 2308 having an upper surface 2310 and a lower surface (not visible in FIG. 23). Offset pins 2314 and 2316 extend from opposite sides 2318 and 2320 of plaque 2308. Upper surface 2310 of plaque 2308 has alpha-numeric indicia 2322. Plaque 2308 has a length lₚ₂₃ indicated by double-headed arrow 2332 and a width wₚ₂₃ indicated by double-headed arrow 2334. In this embodiment, length lₚ₂₃ is also the maximum diameter of plaque 2308. Pins 2314 and 2316 each have a length lₙ₂₃ indicated by double-headed arrow 2338. Indicia 2322 are oriented parallel to length lₚ₂₃. In ear tag 2302, length lₚ₂₃ is greater than width wₚ₂₃. Pins 2314 and 2316 have pointed distal ends 2354 and 2356 respectively. Pointed distal ends 2354 and 2356 taper on two sides so that width wₚ₂₃ of ear tag 2302 is reduced.

FIG. 24 shows one embodiment of a unibody ear tag 2402 of the present invention including a circular plaque 2408 having an upper surface 2410 and a lower surface (not visible in FIG. 24). Offset pins 2414 and 2416 extend from opposite sides 2418 and 2420 of plaque 2408. Upper surface 2410 of plaque 2408 has alpha-numeric indicia 2422. Plaque 2408 has a length lₚ₂₄ indicated by double-headed arrow 2432 and a width wₚ₂₀ indicated by double-headed arrow 2434. The diameter of plaque 2408 is constant and, therefore, corresponds to both lₚ₂₄ and wₚ₂₄. Pins 2414 and 2416 each have a length lₙ₂₀ indicated by double-headed arrow 2438. Indicia 2422 are oriented parallel to length lₚ₂₄. Pins 2414 and 2416 have pointed distal ends 2454 and 2456 respectively. Pointed distal ends 2454 and 2456 taper on two sides so that width wₚ₂₄ of ear tag 2402 is reduced.

FIG. 25 shows one embodiment of a unibody ear tag 2502 of the present invention in a flat configuration 2504. Ear tag 2502 includes a rounded corner rectangular plaque 2508 having an upper surface 2510 and a lower surface (not visible in FIG. 25). Offset pins 2514 and 2516 extend from opposite sides 2518 and 2520 of plaque 2508. Upper surface 2510 of plaque 2508 has alpha-numeric indicia 2522. Plaque 2508 has rounded corners 2524. Plaque 2508 has a length lₚ₂₅ indicated by double-headed arrow 2532 and a width wₚ₂₁ indicated by double-headed arrow 2534. In this embodiment, length lₚ₂₅ is also the maximum diameter of plaque 2508. Pins 2514 and 2516 each have a length lₙ₂₁ indicated by double-headed arrow 2538. Indicia 2522 are oriented parallel to length lₚ₂₅. In ear tag 2502, length lₚ₂₅ is greater than width wₚ₂₁. Pins 2514 and 2516 have pointed distal ends 2554 and 2556 respectively. Pointed distal ends 2554 and 2556 taper on two sides so that width wₚ₂₅ of ear tag 2502 is reduced.

FIGS. 26 and 27 show a pin 2602 of the present invention having a rectangular cross-section according to one embodiment of the present invention with long sides 2606 and short sides 2608. Long sides 2606 and short sides 2606 taper to a point 2612.

Although a rectangular cross-section pin with different length sides is shown in FIGS. 26 and 27, a rectangular pin of the present invention may also have four equal length sides i.e. may have a square cross-section. Also, although a pin with a pointed distal end having four tapered sides are shown in FIGS. 26 and 27, a rectangular cross-section pin of the present invention may have 1, 2, 3 or 4 tapered sides when the pin has a pointed distal end. A rectangular cross-section pointed pin of the present invention may also have no tapered sides, so that the pin is a flat end.

FIGS. 28 and 29 show a cylindrical pin 2802 of the present invention having a circular cross-section according to one embodiment of the present invention. Pin 2802 has a conical end 2812 that tapers to a point 2814.

Although FIGS. 26, 27, 28 and 29 show pins with pointed ends having rectangular and circular cross-section, pins with pointed distal ends of the present invention may have polygonal cross-sections or any other cross-sectional shape.

FIG. 30 shows a pin 3002 according to one embodiment of the present invention having a blunt tapered end 3004. Pin 3002 may have any shape cross-section such as rectangular, square, polygonal, circular, etc.

FIG. 31 shows a pin 3102 according to one embodiment of the present invention having a beveled end 3104. Pin 3202 may have any shape cross-section such as rectangular, square, polygonal, circular, etc.

FIG. 32 shows a pin 3202 according to one embodiment of the present invention having a curved blunt end 3204. Pin 3202 may have any shape cross-section such as rectangular, square, polygonal, circular, etc.

FIG. 33 shows an ear tag 3302 in a flat configuration 3304 according to one embodiment of the present invention. Ear tag 3302 has a plaque 3308 and two offset pins 3314 and 3316. Plaque 3308 includes a 1-dimensional bar code indicia 3322. Pins 3314 and 3316 have pointed distal ends 3354 and 3356 respectively. Pointed distal ends 3354 and 3356 taper on two sides so that width wₚ₃₃ of ear tag 3302 is reduced.

FIG. 34 shows an ear tag 3402 in a flat configuration 3404 according to one embodiment of the present invention. Ear tag 3402 has a plaque 3408 and two offset pins 3414 and 3416. Plaque 3408 includes a 2D bar code indicia 3422. Pins 3414 and 3416 have pointed distal ends 3454 and 3456 respectively. Pointed distal ends 3454 and 3456 taper on two sides so that width wₚ₃₄ of ear tag 3402 is reduced.

FIG. 35 shows an ear tag 3502 in a flat configuration 3504 according to one embodiment of the present invention. Ear tag 3502 has a plaque 3508 and two offset pins 3514 and 3516. Plaque 3508 includes indicia 3522 for a color-based code. Each different color may represent a different number, letter, symbol, etc., or a combination thereof. Pins 3514 and 3516 have pointed distal ends 3554 and 3556 respectively. Pointed distal ends 3554 and 3556 taper on two sides so that width wₚ₃₅ of ear tag 3502 is reduced.

FIG. 36 shows an ear tag 3602 in a flat configuration 3604 according to one embodiment of the present invention. Ear tag 3602 has a plaque 3608 and two offset pins 3614 and 3616. Plaque 3608 includes indicia 3622 for a color-based and shaped-based code. Each different combination of shape and color may represent a different number, letter, symbol, etc., or a combination thereof. Pins 3614 and 3616 have pointed distal ends 3654 and 3656 respectively. Pointed distal ends 3654 and 3656 taper on two sides so that width wₚ₃₆ of ear tag 3602 is reduced.

FIG. 37 shows an ear tag 3702 in a flat configuration 3704 according to one embodiment of the present invention. Ear tag 3702 has a plaque 3708 and two aligned pins 3714 and 3716. Plaque 3708 includes a 2D bar code indicia 3722. Pins 3714 and 3716 have pointed distal ends 3754 and 3756 respectively. Pointed distal ends 3754 and 3756 taper on two sides so that width wₚ₃₇ of ear tag 3702 is reduced.

FIGS. 38, 39 and 40 show one embodiment of a rectangular unibody ear tag 3802 of the present invention in a flat configuration 3804. Ear tag 3802 includes a rectangular plaque 3808 having an upper surface 3810 and a lower surface 3812. Pins 3814 and 3816 extend from opposite sides 3818 and 3820 of plaque 3808. Upper surface 3810 of plaque 3808 has alpha-numeric indicia 3822. Plaque 3808 has a length lₚ₃₈ indicated by double-headed arrow 3832, a width wₚ₃₈ indicated by double-headed arrow 3834 and a maximum diameter dₘₐₓ₃₈ indicated by double-headed arrow 3836. Pins 3814 and 3816 each have a length lₙ₃₈ indicated by double-headed arrow 3838. Plaque 3808 and pins 3814 and 3816 have a thickness tₙ₃₈ shown by bracket 3842. Pins 3814 and 3816 are each rectangular. Indicia 3822 are oriented parallel to length lₚ₃₈. About 15% to about 25% of down the length lₙ₃₈ of pins 3814 and 3818 from where pins 3814 and 3816 join plaque 3808, indicated by arrows 3844 and 3846, are respective preferential bending regions 3848 and 3850. Preferential bending regions 3848 and 3850 are regions of respective pins 3814 and 3816 in which the width of pins 3814 and 3816 are narrowed. A cross section of pin 3814 in a preferential bending region 3848 region of pin 3814 is shown in FIG. 41 and the cross section of pin 3816 in preferential bending region 3850 is identical. A cross section of pin 3814 outside preferential bending region 3848 is shown in FIG. 42 and the cross section of pin 3816 outside preferential bending region 3850 is identical. Length lₚ₃₈ of ear tag 3802 is shown greater than width wₚ₃₈ of ear tag 3802. Length lₙ₃₈ is approximately equal to length lₚ₃₈. Pins 3814 and 3816 each have a minimum width wₙₘᵢₙ₃₈ in respective preferential bending regions 3848 and 3850 shown by bracket 3852. In the remainder of pins 3814 and 3816, each pin has a maximum width wₙₘₐₓ₃₈ shown by bracket 3854. Pins 3814 and 3816 are offset from each other by an offset distance oₚ₃₈ indicated from each other by double-headed arrows 3856. Shadow line 3858 corresponds to an edge of pin 3814 and shadow line 3860 corresponds to an edge of pin 3816. Pins 3814 and 3816 have pointed distal ends 3874 and 3876 respectively. Pointed distal ends 3874 and 3876 taper on two sides so that width wₚ₃₈ of ear tag 3802 is reduced.

FIG. 43 shows ear tag 3802 in an insertion configuration 4304 according to one embodiment of the present invention in which pins 3814 and 3816 have been bent at respective preferential bending regions 3848 and 3850 so that pins 3814 and 3816 bend downwardly at a substantially right angle so that pointed pin distal ends 3874 and 3876 may be inserted through the ear of an animal as shown in FIG. 44.

FIG. 44 show ear tag 3802 in an insertion configuration 4304 in which pins 3814 and 3816 are inserted through animal ear 4406 so that plaque 3808 rests substantially flat against a upper surface 4408 of an animal ear 4406. Animal ear 4406 also includes a lower surface 4410 that is opposite upper surface 4408. Either upper surface 4408 or lower surface 4410 may be the upper or lower surface of the animal ear, with the other surface being the opposite surface.

FIGS. 45 and 46 show ear tag 3802 in a secured configuration 4504 in which pins 3814 and 3816 have been bent at bends 4514 and 4516, respectively, so that retaining sections 4518 and 4520, respectively of pins 3814 and 3816 extend inwardly under plaque 3808. Retaining sections 4518 and 4520 extend substantially parallel to the lower surface 4410 of animal ear 4406 to prevent pins 3814 and 3816 from being pulled upwardly back through ear 4406 and to thereby secure ear tag 3802 to animal ear 4406. Retaining sections are separated from each other by offset distance O_{d38} shown by doubled head arrow 3852.

FIGS. 47, 48 and 49 show one embodiment of a rectangular unibody ear tag 4702 of the present invention in a flat configuration 4704. Ear tag 4702 includes a rectangular plaque 4708 having an upper surface 4710 and a lower surface 4712. Pins 4714 and 4716 extend from opposite sides 4718 and 4720 of plaque 4708. Upper surface 4710 of plaque 4708 has alpha-numeric indicia 4722. Plaque 4708 has a length lₚ₄₇ indicated by double-headed arrow 4732, a width wₚ₄₇ indicated by double-headed arrow 4734 and a maximum diameter dₘₐₓ₄₇ indicated by double-headed arrow 4736. Pins 4714 and 4716 each have a length lₙ₄₇ indicated by double-headed arrow 4738. Plaque 4708 and pins 4714 and 4716 have a thickness tₙ₄₇ shown by bracket 4742. Pins 4714 and 4716 are each rectangular. Indicia 4722 are oriented parallel to length lₚ₄₇. About 15% to about 25% of down the length lₙ₄₇ of pins 4714 and 4718 from where pins 4714 and 4716 join plaque 4708, indicated by arrows 4744 and 4746, are respective preferential bending regions 4748 and 4750. Preferential bending regions 4748 and 4750 are regions of respective pins 4714 and 4716 in which the width of pins 4714 and 4716 are narrowed. A cross section of pin 4714 in a preferential bending region 4748 region of pin 4714 is shown in FIG. 50 and the cross section of pin 4716 in preferential bending region 4750 is identical. A cross section of pin 4714 outside preferential bending region 4748 is shown in FIG. 51 and the cross section of pin 4716 outside preferential bending region 4750 is identical. Length lₚ₄₇ of ear tag 4702 is shown greater than width wₚ₄₇ of ear tag 4702. Length lₙ₄₇ is approximately equal to length lₚ₄₇. Pins 4714 and 4716 each have a minimum width wₙₘᵢₙ₄₇ in respective preferential bending regions 4748 and 4750 shown by bracket 4752. In the remainder of pins 4714 and 4716, each pin has a maximum width wₙₘₐₓ₄₇ shown by bracket 4754. Pins 4714 and 4716 are offset from each other by an offset distance oₚ₄₇ indicated from each other by double-headed arrows 4756. Shadow line 4758 corresponds to an edge of pin 4714 and shadow line 4760 corresponds to an edge of pin 4716. In addition to respective preferential bending regions 4748 and 4750, pins 4714 and 4718 each include a second preferential bending region, preferential bending regions 4768 and 4770, respectively in which the width of pins 4714 and 4716 are narrowed to minimum width wₙₘᵢₙ₄₇. A cross section of pin 4714 in preferential bending region 4768 and a cross section of pin 4716 in bending region 4760 is identical to the cross section of pin 4714 in preferential bending region 4748 shown in FIG. 50. Pins 4714 and 4716 have pointed distal ends 4774 and 4776 respectively. Pointed distal ends 4774 and 4776 taper on two sides so that width wₚ₄₇ of ear tag 4702 is reduced.

FIG. 52 shows ear tag 4702 in an insertion configuration 5204 according to one embodiment of the present invention in which pins 4714 and 4716 have been bent at respective preferential bending regions 4748 and 4750 so that pins 4714 and 4716 bend downwardly at a substantially right angle so that pointed pin distal ends 4774 and 47766 may be inserted through the ear of an animal as shown in FIG. 53.

FIG. 53 show ear tag 4702 in an insertion configuration 5204 in which pins 4714 and 4716 are inserted through animal ear 5306 so that plaque 4708 rests substantially flat against a upper surface 5308 of an animal ear 5306. Animal ear 5306 also includes a lower surface 5310 that is opposite upper surface 5308. Either upper surface 5308 or lower surface 5310 may be the upper or lower surface of the animal ear, with the other surface being the opposite surface.

FIGS. 54 and 55 show ear tag 4702 in a secured configuration 5404 in which pins 4714 and 4716 have been bent at preferential bending regions 4768 and 4770, respectively, so that retaining sections 5418 and 5420, respectively of pins 4714 and 4716 extend inwardly under plaque 4708. Retaining sections 5418 and 5420 extend substantially parallel to the lower surface 5310 of animal ear 5306 to prevent pins 4714 and 4716 from being pulled upwardly back through ear 5306 and to thereby secure ear tag 4702 to animal ear 5306. Retaining sections are separated from each other by offset distance o_{d47} shown by double-headed arrow 4752.

Although the two preferential bending regions for each pin are shown as having identical widths in FIGS. 47, 48 and 52, the two preferential bending regions for each pin have different widths. Also, although the respective bending regions of the two pins in FIGS. 38, 39, 43, 47, 48 and 52 are shown as having the same width, the respective preferential bending regions of the two pins may have different widths.

A preferential bending region may be formed in variety of ways in addition to the ways shown in FIGS. 38, 39, 40, 41, 42, 43, 44, 45, 46, 47, 48, 49, 50, 51, 52, 53, 54 and 55. For example, FIG. 56 shows an ear tag according to one embodiment of the present invention, in which a preferential bending region is made by reducing the thickness of the two pins of the ear in the preferential bending region.

FIG. 56 shows a unibody ear tag 5602 of the present invention in a flat configuration 5604. Ear tag 5602 includes a plaque 5608 having an upper surface 5610 and a lower surface 5612. Pins 5614 and 5616 extend from opposite sides 5618 and 5620 of plaque 5608. Pins 5614 and 5616 each have a length lₙ₅₆ indicated by double-headed arrow 5638. Plaque 5608 and pins 5614 and 5616 have a maximum thickness tₙ₅₆ shown by bracket 5642. Pins 5614 and 5616 have rectangular cross-sections. About 15% to about 25% of down the length lₙ₅₆ of pins 5614 and 5616 from where pins 5614 and 5616 join plaque 5608, indicated by arrows 5644 and 5646, are respective preferential bending regions 5648 and 5650. Pins 5614 and 5616 each have a minimum thickness wₜₘᵢₙ₅₆ in respective preferential bending regions 5648 and 5650 as indicated by bracket 5652. Preferential bending regions 5648 and 5650 are formed by thinning pins 5614 and 5616 relative to upper surfaces 5654 and 5656 and lower surfaces 5664 and 5666 of pins 5614 and 5616, respectively.

FIG. 57 shows a unibody ear tag 5702 of the present invention in a flat configuration 5704. Ear tag 5702 includes a plaque 5708 having an upper surface 5710 and a lower surface 5712. Pins 5714 and 5716 extend from opposite sides 5718 and 5720 of plaque 5708. Pins 5714 and 5716 each have a length lₙ₅₇ indicated by double-headed arrow 5738. Plaque 5708 and pins 5714 and 5716 have a maximum thickness tₙ₅₇ shown by bracket 5742. Pins 5714 and 5716 have rectangular cross-sections. About 15% to about 25% of down the length lₙ₅₇ of pins 5714 and 5716 from where pins 5714 and 5716 join plaque 5708, indicated by arrows 5744 and 5746, are respective preferential bending regions 5748 and 5750. Pins 5714 and 5716 each have a minimum thickness wₜₘᵢₙ₅₇ in respective preferential bending regions 5748 and 5750 indicated by bracket 5752. Preferential bending regions 5748 and 5750 are formed by thinning pins 5714 and 5716 relative to upper surfaces 5754 and 5756 of pins 5714 and 5716, respectively.

FIG. 58 shows a unibody ear tag 5802 of the present invention in a flat configuration 5804. Ear tag 5802 includes a plaque 5808 having an upper surface 5810 and a lower surface 5812. Pins 5814 and 5816 extend from opposite sides 5818 and 5820 of plaque 5808. Pins 5814 and 5816 each have a length lₙ₅₄ indicated by double-headed arrow 5838. Plaque 5808 and pins 5814 and 5816 have a maximum thickness tₙ₅₈ shown by bracket 5842. Pins 5814 and 5816 have rectangular cross-sections. About 15% to about 25% of down the length lₙ₅₈ of pins 5814 and 5816 from where pins 5814 and 5816 join plaque 5808, indicated by arrows 5844 and 5846, are respective preferential bending regions 5848 and 5850. Pins 5814 and 5816 each have a minimum thickness wₜₘᵢₙ₅₈ in respective preferential bending regions 5848 and 5850 indicated by bracket 5852. Preferential bending regions 5848 and 5850 are formed by thinning pins 5814 and 5816 relative to lower surfaces 5864 and 5866 of pins 5814 and 5816, respectively.

Although in FIGS. 56, 57, 58 and 59 only one preferential bending region is shown for each pin, there may be two preferential bending regions of the types shown in FIGS. 56, 57, 58 and 59 for each pin in an arrangement similar to that shown for the preferential bending regions 47, 48, 49, 50, 51, 52, 53, 54 and 55. The two preferential bending regions may both be the same type of preferential bending region or may be different types of preferential bending regions. For example, one preferential bending region for each pin may have a reduced width and the other preferential bending region may have a reduced thickness.

Although the embodiments of the ear tag of the present invention shown in the embodiments of 1, 2, 5, 6, 9, 13, 14, 17, 21, 22, 23, 24, 25, 26, 27, 33, 34, 35, 36, 37, 38, 39, 43, 44, 45, 46, 47, 48, 52, 53, 54, 55. 56, 57 and 58 only have one pin extending from each of two opposite sides of the plaque, in some embodiments of the present invention, as shown in FIG. 59, there may be two or more pins per side.

FIG. 59 shows one embodiment of a rectangular unibody ear tag 5900 of the present invention in a flat configuration 5902. Ear tag 5900 includes a rectangular plaque 5904 having an upper surface 5906 and a lower surface (not visible in FIG. 59). Pins 5908 and 5910 extend from one side 5912 of plaque 5904. Pins 5914 and 5916 extend from opposite side 5918 of plaque 5904. Upper surface 5906 of plaque 5904 has alpha-numeric indicia 5922. Plaque 5904 has a length lₚ₅₉ indicated by double-headed arrow 5932, a width wₚ₅₉ indicated by double-headed arrow 5934 and a maximum diameter dₘₐₓ₅₉ indicated by double-headed arrow 5936. Pins 5908, 5910, 5914 and 5916 each have a length lₙ₅₉ indicated by double-headed arrow 5938. Pins 5908 and 5910 are offset relative to pins 5914 and 5916 to prevent pins 5908 and 5910 from contacting pins 5914 and 5916 when pins 5908, 5910, 5914 and 5916 are folded under to secure ear tag 5900 to an animal ear (not shown in FIG. 59) in a fashion similar to what is shown for the ear tag of FIGS. 45 and 46. Indicia 5922 are oriented parallel to length lₚ₅₉. In ear tag 5900, length lₚ₅₉ is shown greater than width wₚ₅₉, and length lₙ₅₉ is approximately equal to length lₚ₅₉. Pins 5908, 5910, 5914 and 5916 have pointed distal ends 5958, 5960, 5962 and 5964, respectively.

In some embodiments, the pins of the ear tag of the present invention may extend from more than two sides. For example, the pins may extend from all four sides of a rectangular plaque as shown in FIG. 60.

FIG. 60 shows one embodiment of a rectangular unibody ear tag 6000 of the present invention in a flat configuration 6002. Ear tag 6000 includes a rectangular plaque 6004 having an upper surface 6006 and a lower surface (not visible in FIG. 60). Pins 6008 and 6010 extend from respective opposite sides 6012 and 6014 of plaque 6004. Pins 6016 and 6018 extend from respective opposite sides 6020 and 6022 of plaque 6004. Upper surface 6006 of plaque 6004 has alpha-numeric indicia 6024. Plaque 6004 has a length lₚ₆₀ indicated by double-headed arrow 6032, a width wₚ₆₀ indicated by double-headed arrow 6034 and a maximum diameter dₘₐₓ₆₀ indicated by double-headed arrow 6036. Pins 6008 and 6010 each have a length lₙ₆₀ₐ indicated by double-headed arrow 6038. Pins 6016 and 6018 each have a length l_{n60b} indicated by double-headed arrow 6040. Indicia 6024 are oriented parallel to length lₚ₆₀. In ear tag 6000, length lₚ₆₀ is shown greater than width wₚ₆₀. Length lₙ₆₀ₐ is substantially less than half the length lₚ₆₀, and length l_{n60b} is less than half the width wₚ₆₀ to allow pins 6008, 6010, 6016 and 6018 to be folded under plaque 6004 without contacting each other when pin 6000 is secured to an animal ear (not shown in FIG. 60). Pins 6008, 6010, 6016 and 6018 have pointed distal ends 6058, 6060, 6066 and 6068, respectively.

FIGS. 61 and 62 show one embodiment of rectangular ear tag 6102 of the present invention in a flat configuration 6104. Ear tag 6102 includes a rectangular plaque 6108 having an upper surface 6110 and a lower surface 6112. Offset pins 6114 and 6116 extend from opposite sides 6118 and 6120 of plaque 6108. Mounted on upper surface 6110 of plaque 6108 is a RFID tag 6122. Pins 6114 and 6116 have pointed distal ends 6154 and 6156, respectively.

FIGS. 63 and 64 show one embodiment of a rectangular ear tag 6302 of the present invention in a flat configuration 6304. Ear tag 6302 includes a rectangular plaque 6308 having an upper surface 6310 and a lower surface 6312. Offset pins 6314 and 6316 extend from opposite sides 6318 and 6320 of plaque 6308. Mounted inside plaque 6308 is a RFID tag shown by shadow-line box 6322. Pins 6314 and 6316 have pointed distal ends 6354 and 6356, respectively.

The indicia of the present invention, such as the indicia shown in the embodiments of FIGS. 1, 2, 5, 6, 9, 13, 14, 17, 21, 22, 23, 24, 25, 26, 27, 33, 34, 35, 37, 38, 39, 43, 47, 48, 52, 59 and 60 may be formed in a variety of ways. For example, the indicia may be engraved in a plaque or etched in a plaque. The indicia may be formed on a plaque as raised indicia, painted on a plaque, deposited on a plaque, etc. The indicia may also be part of a label that is adhered to a plaque. The indicia may include various combinations of types of indicia.

Although in the embodiment of the present invention shown in FIGS. 1, 2, 5, 6, 9, 13, 14, 17, 21, 22, 23, 24, 25, 26, 27, 33, 34, 35, 37, 38, 39, 43, 47, 48, 52, 59 and 60, the indicia is only shown as being on the upper surface of the plaque, there may also be indicia on the lower surface of the plaque.

The maximum dimensions of the plaque and pins and maximum weight of the ear tag may vary depending on the size of the ear of the animal to which the ear tag of the present invention is to be attached. In general, a lighter and smaller ear tag is advantageous and preferred since lighter and smaller ear tags will likely cause less physical irritation to the animal and are more likely to remain attached to the ear because they have less weight and rest delicately on the surface of the ear. Lighter and smaller ear tags are also less likely to distract or alter the behavior of the animal. The ear tag should be smaller than the surface area of the ear of the animal and not extend beyond the outer rim of the ear. More preferably, the ear tag should be substantially smaller than the surface area of the ear of the animal and minimize its size relative to the size of the ear. According to some embodiments, ear tag of present invention may also have rounded corners to improve comfort and minimize agitation for the animal.

In one embodiment, the plaque is less than about 6.0 mm in length. In another embodiment, the plaque may be less than about 5.0 mm in length. For example, the plaque may be about 2.0 mm to about 5.0 mm in length. In one embodiment, the plaque is less than about 6.0 mm in width. In another embodiment, the plaque may be less than about 5.0 mm in width. For example, the plaque may be about 2.0 mm to about 5.0 mm in width. In one embodiment, the maximum diameter may be about 8.5 mm or less. In another embodiment, the maximum diameter may be about 7.1 mm to about 2.8 mm.

When the code for the ear tag is present as visible indicia, the minimize size of the plaque may be dependent on the minimum size of the indicia that may be read human or by a machine. When the code for the ear tag is machine-readable code, such as a RFID tag, the plaque may be made very small since such machine-readable code does not require direct visual inspection or reading by a human. Where a RFID tag is used, the coil may be positioned around the perimeter or edge of the plaque with the chip positioned near the center of the plaque. In an alternate configuration, the chip may be to the side of coil. In one embodiment, the maximum weight of the tags is less than about 0.06 g, more preferably less than about 0.03 g, and more preferably less than about 0.02 g. Alternate design the tag body may be of a mesh or grid design with the RFID positioned behind the grid.

The pins of the ear tag of the present invention have a minimum width of about 0.3 mm to allow the pins to have sufficient structure and strength to pierce the ear of an animal, such as a mouse. In one embodiment, the width of the pins is 50% or less the width of the plaque. The length of the pins may vary from about the length of the plaque to about 50% of the length of the plaque so that the pins are long enough to be folded under the plaque and/or to penetrate the ear of an animal, yet not too long so that the pins do not extend beyond the opposite side of the plaque when folded under the plaque. Although pins have sufficient thickness for strength, it is important that pins of ear tags are also sufficiently thin to not tear the ear of the animal. According to one embodiment, pins of present ear tags have a thickness that is approximately the same to width to a thickness that is about 10% of the width. In another embodiment the width may be approximately the same as the thickness to about 10% of the thickness.

The ear tag of the present invention may be made of various materials having one or more of the following characteristics: non-bioreactivity, high chew resistance, low density, high tensile strength, at least some ductility, and sterilizability. It may also be preferable for ear tag of present invention to have a unibody construction to increase its resiliency and/or strength as well as to facilitate and/or reduce cost of its manufacture. The strength of ear tags of present invention may be especially important given the extremely small size of embodiments of present ear tags. For example, the pins need to be sufficiently stiff to allow the pins to be inserted through an animal's ear. Yet it is also important that the pins have sufficient ductility and/or include preferential bending regions to allow the pins to be bent during the process of securing the ear tag to the animal's ear. In one embodiment, ear tag of the present invention may be made of metals such as stainless steel, aluminum, titanium, metal alloys, etc. There are also plastic that have similar ductile properties to metals and are hard enough to resist chewing. The tag can also be made from a composite sheet of two or more layers of materials with different properties to achieve the desired “chew resistance” and ductility.

In regards to chew resistance, it has been reported that mouse enamel has a hardness comparable to middle steel and approximately half of the value of geological apatite. Also, human enamel, which is similar to mouse enamel has a biological organization of hydroxyapatite crystallites into a fibrous continuum toughens and controls anisotropy in human enamel, see White S N, Luo W, Paine M L, Fong H, Sarikaya M, Snead, “Biological organization of hydroxyapatite crystallites into a fibrous continuum toughens and controls anisotropy in human enamel,” J. Dent. Res. Jan; 80(1):321-326 (2001), and human enamel has a hardness is intermediate between that of iron and carbon steel”, see J. D. Bartlett, E. Beniash, D. H. Lee, and C. E. Smith, “Decreased Mineral Content in MMP-20 Null Mouse Enamel is Prominent During the Maturation Stage,” J. Dent. Res., 83(12): 909-913 (2004). Therefore, materials should be strong enough to withstand biting or chewing by the animal considering the hardness of its enamel. In one embodiment, the ear tag is made of a material that is able to withstand one or more sterilizing systems such as: H₂0₂ vapor, ethylene dioxide, autoclaving, 70% ethanol, gamma radiation, etc.

Although in FIGS. 10, 11, 18, 19, 44, 45, 53 and 54 the animal ears are each shown as having straight parallel upper and lower surfaces, an actual animal ear, such as a rodent has undulations. Also, many animal ears have hair or fur. Therefore, for the purposes of the present invention, a plaque that lies “substantially flat” on an animal ear will often rest on hair, fur, ear undulations, etc. of one surface of the animal ear that may cause there to be small air spaces between the plaque and the animal ear. The situation is similar for the retaining sections of the pins that lie “substantially flat” on the opposite surface the animal ear or extend “substantially parallel” to the opposite surface of the animal ear.

Also, although the terms “upper surface” and “lower surface” are used to describe the surfaces of each of the animal ears in FIGS. 10, 11, 18, 19, 44, 45, 53 and 54 the descriptions of the other drawings below, these terms are purely for convenience in describing the drawings. The “upper surface” may be either the dorsal or ventral surface of an ear and the “lower surface” may be the ventral or dorsal portion of the ear.

An ear tag of the present invention may be secured to an animal's ear by bending the pins and inserting the pins in the ear. For example, an ear tag may be secured by the following procedure by manually bending the pins once the pins are inserted through the animal's ear. A pliers or other device may also be used to bend the pins.

FIG. 65 and FIG. 66 show two different orientations for securing ear tags of the present invention to the ear of a 14 day old mouse. For simplicity of illustration, the pins of the ear tags have been omitted in FIGS. 65 and 66.

FIG. 65 shows a ear tag 6502 mounted on a mouse ear 6504 in a position 6504 that is approximately perpendicular to a major axis of growth elongation 6506 of mouse ear 6504. Ear tag 6502 includes a 2D bar code 6512. The distance indicated by double-headed arrow 6514 is 1 cm.

FIG. 66 shows a ear tag 6602 mounted on a mouse ear 6604 in a position 6604 that is approximately parallel to a major axis of growth elongation 6606 of mouse ear 6604. Ear tag 6602 includes a 2D bar code 6612. The distance indicated by double-headed arrow 6614 is 1 cm.

The particular position in which the ear tag of the present invention is secured in a give application may be dependent on a variety of factors. For example, depending on the type of bar code reader used, the 2D bar code on the ear tag in the position of FIG. 65 may be easier to read than the 2D bar code on the ear tag in the position of FIG. 66, or vice versa. Also, the ear tag position of FIG. 65 may result in less tissue damage, because the ear tag is further from the ear cartilage, but the ear tag position of FIG. 66 may have less folding/wrinkling of the ear because the surface is flatter in that direction.

Although the ear tags shown in FIGS. 1, 2, 5, 6, 9, 13, 14, 17, 21, 22, 23, 24, 25, 26, 27, 33, 34, 35, 37, 38, 39, 43, 47, 48, 52, 59 and 60 have a unibody construction, the ear tag of the present invention may be made in two or more pieces. For example, as in FIGS. 61 and 62, the RFID tag may be mounted onto plaque of the ear tag. Alternatively, as shown in FIGS. 63 and 64, the RFID tag may be placed inside the plaque of the ear tag. In addition, a label with indicia may be applied to the surface of the plaque of an ear tag.

According to yet further examples, the plaque and pins of present ear tags may be made from different materials. Also, the plaque and pins may be made from the same material and the plaque may include two or more materials. For example, the plaque and pins may be made of metal, and the plaque may include an additional material layer, such as a ceramic or polymeric layer, having indicia etched therein or printed thereon. Where two or more materials are used, any combination of materials may be used. The etching may be by laser etching, chemical, etc.

FIG. 67 shows a strip 6700 including five ear tags 6702, 6704, 6706, 6708 and 6710. Ear tags 6702, 6704, 6706, 6708 and 6710 have respective sequential indicia 6712, 6714, 6716, 6718 and 6720. Ear tag 6702 is connected to ear tag 6704 by a frangible connection 6722. Ear tag 6704 is connected to ear tag 6706 by frangible connection 6724. Ear tag 6706 is connected to ear tag 6708 by frangible connection 6726. Ear tag 6708 is connected to ear tag 6710 by frangible connection 6728. Ear tags 6702, 6704, 6706, 6708 and 6710 each have respective offset pins 6744 and 6746 Pins 6744 and 6746 have respective pointed ends 6748 and 6750.

Although only one type of pin configuration is shown in FIG. 67, a strip of ear tags may have various pin configurations, such as non-offset pins, two pins per side, etc.

To use an individual ear tag of the strip of ear tags of FIG. 67, the frangible connections between the ear tag and the one (or two) adjacent ear tags is broken either human or by operation of an applicator in which the strip is loaded. If the strip of ear tags is formed of one piece of material, the frangible connection according to some embodiments may be a weakened or thinned piece of the material. Alternatively, the frangible connection of other embodiments may be an adhesive used to connect the adjacent ear tags in the strip similar to the way that staples are held together in a strip of staples.

A sequential set of ear tags, such as the strip of ear tags shown in FIG. 67, may be secured to an animal's ear using an application device similar to Stoelting's Autoclip® Applier. The Autoclip® Applier works similarly a staple gun to rapidly apply steel clip closures. There is no need for assistance to operate the applier or remover. When the wound is healed, clips are easily removed with the Autoclip or EZ Clip Remover. Although the strip of ear tags shown in FIG. 67 shows each of the ear tags in a flat configuration, the ear tags in a strip of ear tags may also be bent in some embodiments of the present invention to facilitate their use or application. The pins of the ear tags may extend strait out from the plaque as shown in FIG. 67 or may be partially pre-bent similar to the way that staples or Autoclips® are pre-bent, prior to be applied.

FIG. 68 shows a strip 6800 including ten ear tags 6802, 6804, 6806, 6808, 6810, 6812, 6814, 6816, 6818 and 6820. Ear tags 6802, 6804, 6806, 6808, 6810, 6812, 6814, 6816, 6818 and 6820 have respective sequential indicia 6822, 6824, 6826, 6828, 6830, 6832, 6834, 6836, 6838 and 6840. Ear tag 6802 is connected to ear tag 6804 by a frangible connection 6842. Ear tag 6804 is connected to ear tag 6806 by a frangible connection 6844. Ear tag 6806 is connected to ear tag 6808 by a frangible connection 6842. Ear tag 6808 is connected to ear tag 6810 by a frangible connection 6842. Ear tag 6810 is connected to ear tag 6812 by a frangible connection 6842. Ear tag 6812 is connected to ear tag 6814 by frangible connection 6842. Ear tag 6814 is connected to ear tag 6856 by a frangible connection 6842. Ear tag 6816 is connected to ear tag 6818 by a frangible connection 6842. Ear tag 6818 is connected to ear tag 6820 by A frangible connections 6842. Each frangible connection 6842 includes two tabs 6852 and 6854. Tabs 6852 and 6854 are bordered by respective indents 6856 and 6858 and are separated from each other by an opening 6860. Ear tags 6802, 6804, 6806, 6808, 6810, 6812, 6814, 6816, 6818 and 6820 each have a plaque 6862. Projecting from opposite sides of each plaque 6862 are respective pins 6864 and 6866 having respective pointed ends 6868 and 6870. Each plaque 6862 has an X-dimension 6872 and a Y-dimension 6874. Each pin 6864 and 6866 has an X-dimension 6876, a non-tapered portion X-dimension of 6878 and a Y-dimension 6880. Each opening 6856 and indent 6858 and 6860 has a Y-dimension 6882. X-dimension 6876 of pins 6868 and 6870 is longer than X-dimension 6872 of plaques 6862. Strips of tags are not limited to 10 on a strip and large number (hundreds) of tags can be combined on a roll for ease of sequential use with an application device.

In some embodiments of the ear tags of FIG. 68, each plaque has a X-dimension of at least about 0.1450 inches and a Y-dimension of at least about 0.1050 inches; each pin has an X-dimension of at least about 0.163 inches, a non-tapered portion X-dimension of at least about 0.142 and a Y dimension of at least about 0.018 inches; and each opening and indent has a Y-dimension of at least 0.006 inches. In one embodiment of the ear tags of FIG. 68, each plaque has an X-dimension of about 0.1470 inches and a Y-dimension of about 0.1070 inches, each pin has an X-dimension of about 0.168 inches, a non-tapered portion X-dimension of about 0.145 and a Y dimension of about 0.022 inches, and each opening and indent has a Y-dimension of about 0.010 inches. In some embodiments the ear tags of FIG. 68 may have a thickness of about 0.10 inches.

In some embodiments of FIG. 68, the opening and indents that form the tabs may be made by etching.

Although strips of 5 and 10 ear tags are shown in FIGS. 67 and 68, respectively, a strip of any number of ear tags may be used in a strip of ear tags and long strips of ear tags may be in the form of a roll. For example, there may be hundreds of ear tags in a roll of ear tags for ease of sequential use with an application device.

Although a particular type of indicia is shown in the strip of ear tags in FIGS. 67 and 68, various types of sequential indicia may be used on the ear tags of the strip, including human-readable indicia, machine-readable indicia such as 1-dimensional and 2D bar codes, color-based indicia, symbol-based indicia, shaped-based indicia, etc. Also, instead of visible indicia, a strip of sequential ear tags may include ear tags having machine-readable codes, such as RFID tags.

Also, although particular types of pins are shown in FIGS. 67 and 68, a strip of ear tags of the present invention may have various types of pin configurations and types. Also, the pins may be shorter or longer in the X-dimension that the plaques in a strip of ear tags.

Metal ear tags and strips of ear tags of the present invention may be made from a metal sheet by well-known processes such as laser etching, metal stamping, etc.

All documents, patents, journal articles and other materials cited in the present application are hereby incorporated by reference. Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. An ear tag comprising:
a plaque having a substantially flat shape and having an identification code; and
two or more pins connected to the plaque for securing the ear tag to the ear of an animal; wherein at least two of the pins are each connected to each of two opposite sides of the plaque, respectively; and wherein the ear tag has a weight of about 0.06 g or less.

2. The ear tag of claim 1, wherein the ear tag has a weight of about 0.03 g or less.

3. The ear tag of claim 1, wherein the ear tag has a weight of about 0.02 g or less.

4. The ear tag of claim 1, wherein the ear tag has a unibody construction.

5. The ear tag of claim 1, wherein two or more of the pins have pointed distal ends.

6. The ear tag of claim 1, wherein the animal is a rodent.

7. The ear tag of claim 1, wherein the plaque lies substantially flat against a surface of the ear of the animal when secured to the ear.

8. The ear tag of claim 1, wherein the plaque has a length of about 6.0 mm or less.

9. The ear tag of claim 1, wherein the plaque has a width of about 6.0 mm or less.

10. The ear tag of claim 1, wherein the width of the pin is at least 50% or less the width of the plaque.

11. The ear tag of claim 1, wherein the pins on opposite sides of the ear tag are offset with respect to each other.

12. The ear tag of claim 1, wherein the two or more pins are bent for inserting in the ear of an animal and securing the ear tag to the ear of the animal.

13. The ear tag of claim 1, wherein the identification code comprises indicia.

14. The ear tag of claim 13, wherein the plaque comprises an upper surface and a lower surface, and the indicia is present on at least one surface of the plaque.

15. The ear tag of claim 14, wherein the indicia is engraved or etched onto at least one surface of the plaque.

16. The ear tag of claim 14, wherein the indicia is present on both the upper surface and bottom surface of the plaque.

17. The ear tag of claim 13, wherein the indicia comprise human-readable indicia.

18. The ear tag of claim 13, wherein the indicia comprise alpha-numeric indicia.

19. The ear tag of claim 13, wherein the indicia comprise color-based indicia.

20. The ear tag of claim 13, wherein the indicia comprise shape-based indicia.

21. The ear tag of claim 13, wherein the indicia comprise symbols.

22. The ear tag of claim 13, wherein the indicia comprise a machine-readable indicia.

23. The ear tag of claim 13, wherein the indicia comprise a 1-dimensional bar code.

24. The ear tag of claim 13, wherein the indicia is a 2D bar code.

25. The ear tag of claim 1, wherein the identification code is provided by a RFID tag.

26. The ear tag of claim 25, wherein the plaque comprises an upper surface and a lower surface, wherein the RFID tag is present on the upper surface of the plaque.

27. The ear tag of claim 25, wherein the RFID tag is placed inside the plaque.

28. The ear tag of claim 1, wherein each pin includes a preferential bending region.

29. The ear tag of claim 28, wherein each preferential bending region is located at a distance of about 15-25% of the length of each pin from the proximal end of each respective pin.

30. The ear tag of claim of claim 28, wherein the width of each pin in the respective preferential bending regions is reduced relative to the width of each pin outside the preferential bending region.

31. The ear tag of claim of claim 28, wherein the thickness of each pin in the respective preferential bending regions is reduced relative to the thickness of each pin outside the preferential bending region.

32. The ear tag of claim 1, wherein each pin includes two preferential bending regions.

33. The ear tag of claim 32, wherein one preferential bending region of each pin is located at a distance of about 15-25% of the length of each pin from the proximal end of each respective pin.

34. The ear tag of claim of claim 32, wherein the width of each pin in the respective preferential bending regions is reduced relative to the width of each pin outside the preferential bending region.

35. The ear tag of claim of claim 32, wherein the thickness of each pin in the respective preferential bending regions is reduced relative to the thickness of each pin outside the preferential bending region.

36. The ear tag of claim 32, wherein the width of each pin in one of the respective preferential bending regions is reduced relative to the width of each pin outside the one preferential bending region, and wherein the thickness of each pin in the other respective preferential bending region of each pin is reduced relative to the thickness of each pin outside said other preferential bending region.

37. The ear tag of claim 1, wherein the ear tag is comprised of stainless steel.

38. The ear tag of claim 1, wherein the ear tag is comprised of titanium.

39. An article comprising:
a set of ear tags, each ear tag comprising:
a plaque having a substantially flat shape and having an identification code; and
two or more pins connected to the plaque for securing the ear tag to the ear of an animal; and
a connection between each pair of adjacent ear tags of the set of ear tags: wherein at least two of the pins are each connected to each of two opposite sides of the plaque, respectively; wherein each ear tag has a weight of about 0.06 g or less;
and wherein the set of ear tags is a sequential set of ear tags.

40. The article of claim 39, wherein the connection between each pair of adjacent ear tags is a frangible connection.

41. The article of claim 39, wherein two or more of the pins of each ear tag have pointed distal ends.

42. A method comprising the following steps:
(a) inserting each of the two or more pins of an ear tag into the ear of an animal so that a plaque of the ear tag sits substantially flat and immobilized on one surface of an animal ear; and
(b) bending each of the pins so that the pins are substantially parallel to a second surface of the animal ear to thereby secure the ear tag to the animal ear, wherein the plaque has an identification code and the two or more pins extend downwardly from the plaque in step (a).

43. The method of claim 42, wherein the pins are bent under the plaque in step (b).

44. The method of claim 42, wherein the pins are bent outwardly from the plaque in step (b).

45. The method of claim 42, further comprising the following step: (c) bending the two or more pins downwardly prior to step (a).

46. The method of claim 42, wherein two or more of the pins of the ear tag have pointed distal ends.

47. The method of claim 42, wherein the ear tag includes two pins and each of the pins extend from an opposite side of the plaque.

48. The method of claim 47, wherein two or more of the pins are offset with respect to each other.

49. The method of claim 42, wherein the ear tag includes four or more pins and two or more pins extend from a first side of the plaque and two or pins extend from a second side of the plaque opposite the first side of the plaque.

50. The method of claim 49, wherein the two pins extending from the first side of the plaque are offset with respect to the two pins extending from the second side of the plaque.

51. The method of claim 42, wherein the plaque is oriented substantially perpendicular to the major axis of growth elongation of the animal ear after the plaque is secured.

52. The method of claim 42, wherein the plaque is oriented substantially parallel to the major axis of growth elongation of the animal ear after the plaque is secured.

53. The method of claim 42, wherein the ear tag has a unibody construction.

54. The method of claim 42, wherein the animal is a rodent.

55. The method of claim 42, wherein the ear tag has a weight of about 0.06 g or less.

56. The method of claim 42, wherein the ear tag has a weight of about 0.03 g or less.

57. The method of claim 42, wherein the ear tag has a weight of about 0.02 g or less.

58. The method of claim 42, wherein the plaque has a length of about 6.0 mm or less.

59. The method of claim 42, wherein the plaque has a width of about 6.0 mm or less.

60. The method of claim 42, wherein the width of the pin is at least 50% or less the width of the plaque.

61. The method of claim 42, wherein the identification code comprises indicia.

62. The method of claim 61, wherein the plaque comprises an upper surface and a lower surface, and the indicia is present on at least one surface of the plaque.

63. The method of claim 62, wherein the indicia is engraved or etched onto at least one surface of the plaque.

64. The method of claim 62, wherein the indicia is present on both the upper surface and bottom surface of the plaque.

65. The method of claim 61, wherein the indicia comprise human-readable indicia.

66. The method of claim 61, wherein the indicia comprise alpha-numeric indicia.

67. The method of claim 61, wherein the indicia comprise color-based indicia.

68. The method of claim 61, wherein the indicia comprise shape-based indicia.

69. The method of claim 61, wherein the indicia comprise symbols.

70. The method of claim 61, wherein the indicia comprise a machine-readable indicia.

71. The method of claim 61, wherein the indicia comprise a 1-dimensional bar code.

72. The method of claim 61, wherein the indicia is a 2D bar code.

73. The method of claim 42, wherein the identification code is provided by a RFID tag.

74. The method of claim 73, wherein the plaque comprises an upper surface and a lower surface, wherein the RFID tag is present on the upper surface of the plaque.

75. The method of claim 42, wherein the RFID tag is placed inside the plaque.

76. The method of claim 42, wherein each pin includes a preferential bending region.

77. The method of claim 76, wherein each preferential bending region is located at a distance of about 15-25% of the length of each pin from the proximal end of each respective pin.

78. The method of claim of claim 76, wherein the width of each pin in the respective preferential bending regions is reduced relative to the width of each pin outside the preferential bending region.

79. The method of claim of claim 76, wherein the thickness of each pin in the respective preferential bending regions is reduced relative to the thickness of each pin outside the preferential bending region.

80. The method of claim 42, wherein each pin includes two preferential bending regions.

81. The method of claim 80, wherein one preferential bending region of each pin is located at a distance of about 15-25% of the length of each pin from the proximal end of each respective pin.

82. The method of claim of claim 80, wherein the width of each pin in the respective preferential bending regions is reduced relative to the width of each pin outside the preferential bending region.

83. The method of claim of claim 80, wherein the thickness of each pin in the respective preferential bending regions is reduced relative to the thickness of each pin outside the preferential bending region.

84. The method of claim 80, wherein the width of each pin in one of the respective preferential bending regions is reduced relative to the width of each pin outside the one preferential bending region, and wherein the thickness of each pin in the other respective preferential bending region of each pin is reduced relative to the thickness of each pin outside said other preferential bending region.

85. The method of claim 42, wherein the ear tag is comprised of stainless steel.

86. The method of claim 42, wherein the ear tag is comprised of titanium.
